(19) United States
(12) Patent Application Publication
(10) Pub. No.: US 2010/0303061 A1
(43) Pub. Date: Dec. 2, 2010

(54) NETWORK COMMUNICATION SYSTEM FOR SUPPORTING NON-SPECIFIC NETWORK PROTOCOLS AND NETWORK COMMUNICATION METHOD THEREOF

(75) Inventors: Yun-Lung Wan, Taipei City (TW); Chuang Li, Saratoga, CA (US)

Correspondence Address: ROGER H. CHU, 19499 ERIC DRIVE, SARATOGA, CA, 95070, US

(73) Assignee: INFOACTION TECHNOLOGY, INC., Taipei (TW)

(21) Appl. No.: 12/790,988

(22) Filed: Jun. 1, 2010

Related U.S. Application Data
(60) Provisional application No. 61/183,007, filed on Jun. 1, 2009.

(51) Int. Cl. H04L 12/66; H04M 3/00

(52) U.S. Cl. 370/352; 379/242

(57) ABSTRACT

The present invention is related to a technology of unified communication systems. In detail, the present invention is applied to a management of the communications of an enterprise end, that is, the combinations of the on-line presence of each user end and gateways in the enterprise end are brought into practice through variable embodiments. Hence, the number of each user end and the representative number of the enterprise end can be shown to represent the presence of on-line of the user end. More particularly, the present invention is focused on a network communication system for supporting non-specific network protocols and a network communication method thereof.

### CROSS REFERENCE TO RELTED APPLICATIONS

This application claims priority from a co-pending U.S. Provisional Patent Application Ser. No. 61/183,007 for “SYSTEMS AND METHODS FOR CONSTRUCTING ENTERPRISE IP TELEPHONY WITH THE USE OF MULTI-PROTOCOLS AND USER PRESENCES ON A VoIP GATEWAY”, filed on Jun. 1, 2009, the entire contents of which are incorporated herein by reference

### BACKGROUND OF THE INVENTION

1. Field of the Invention

The present invention is related to a technology of unified communication systems. In detail, the present invention is applied to a management of the communications of an enterprise end, that is, the combinations of the on-line presence of each user end and gateways in the enterprise end are brought into practice through variable embodiments. Hence, the number of each user end and the representative number of the enterprise end can be shown to represent the presence of on-line of the user end, and the actions of call-in and call-out can be proceeded. More particularly, the present invention is focused on a network communication system for supporting non-specific network protocols and a network communication method thereof.

2. Description of the Prior Art

There are two major challenges in deploying enterprise-grade Voice over IP(VoIP) telephony system, first, an enterprises applies VoIP Gateway to converge legacy PBX system due to lower costs for transition; FIG. 1 is a schematic view showing a conventional gateway structure; second, Instant Messaging System (IMS), such as Skype, MSN Messenger, Yahoo Messenger and Google Talk, etc., is increasing in popularity in both professional and personal applications, because it allows users to see whether a chosen friend or co-worker is connected to the Internet. the almost immediate two-way nature of communication, many users feel that the use of instant messaging in the workplace leads to more effective and efficient workplace communications and, therefore, to higher productivity. Moreover, IMS allows users to use for free, so that a huge global IMS user community has been established. Therefore, if an enterprise network and IMS are converged together, it is expected that enterprise internal and external communications can significantly benefit by decrease in communication costs and by increase of efficiency.

However, the functions and services provided by a conventional enterprise VoIP gateway fail to meet manifold demands and requirements of modern enterprises without a complicated management framework provided and the cost saving percentage is limited. On the other hand, as with most things Internet based, the increasing use of instant messaging has led to an associated increase in the number of security risks. So enterprises hesitate to implement IMS within the organizations.

Moreover, there are many Instant Messenger systems (IMS) for network communication, such as MSN messenger, Yahoo messenger and Google talk. IMSs described above provide a presence function for determining whether the time is available to communicate with a callee end.

As shown in FIG. 1, a Voice over Internet Protocol (VoIP) sends the signaling packet to the gate device 1 through the Internet 3. The gate device 1 processes the packeted signal by using an audio streaming unit 5 and a control signal unit 6, so that the digital signal (signaling packet) is tramsimited to an exchanging mechanism 2 by way of Time Division Multiplex (TDM), or is transmitted to the exchanging mechanism 2 and further transmitted to the user telephone through a Public Switched Telephone Network (PSTN).

However, the gateway device is generally with no above-mentioned function, so that, when a caller calls a callee end in an enterprise end, and the call is forwarded to the exchanging mechanism 2 or an international call, but the callee end is not there, therefore the charge for the call is wasted.

If a gateway device is able to display user online presence, deliver Instant Message (IM) and perform as an IM network gatekeeper, such issues have become heavily focused subjects to be improved.

With rapid development of Unified Communications (UC) in recent years, it is expected that UC applications are able to be the focus of an enterprise communications in the near future; please refer to FIG. 2, a structure of the Unified Communication (UC) deployment. For such structure, the point is to use a unified user interface 100 to work with different Portals 101, devices 102, office applications 103, and specific applications 104. Therefore, variable services as a mobile communication 110, a contact center 111, a presence and IM 112, a conference 113, a collaboration service 114, a voice mail and UM 115, a telephone communications 116, etc. are provided for communications.

Unified Communications (UC) application enables employees within an organization to apply a single platform, a single device, a single interface and one personal account to log in the network for receiving and sending E-mails, Voice Mails, fax, and presences of other colleagues at the same time, moreover, initiating telephone calls or video conference over internet, sending short messages and calling to a mobile phone No. However, most of the existing technologies and applications apply Session Initiation Protocol (SIP) in support of Unified Communications (UC), but Skype P2P applications are not converged yet, so that a more complete UC application is not achieved.

FIG. 3 illustrates a schematic view of Microsoft Office Communications Server (MS OCS) deployment to a SIP-based environment.

Any new function may need to be remodeled. Thus, a large amount of servers has to be disposed. As shown in figure, the user end can communicate with the enterprise end through MSN190, Yahoo191, AOL192, telephone 195, mobile phone 194, and therefore the large amount of servers are able to support the structure of UC, but such situation may have a huge budget or cost for building up the structure. Further, high complexity causes high cost to maintain. Due to using SIP and public networks, the quality of communications cannot be good. The settings of network parameters have their own fixation or compatibility while using SIP, and are hardly moved. Once the server or communication terminal is moved or the medium device is altered, the settings of the system and voice quality shall be adjusted right away. While SIP is constructed all over the world, trouble-shooting shall count on experienced engineers. The flexibility of using the system to maintain a high quality of an SIP network telephone system is lower. On the other hand, to manage the system may need excellent engineers, who can be employed by large size of companies.

FIG. 4 illustrates a structure of the Skype application, as shown that Skype is a peer-to-peer (P2P) software and is able to find optional communication routes with Skype super nodes. Therefore, an enterprise needs not to purchase additional server systems or VPN bandwidth to perform high quality of communications; moreover, the advanced dynamic encryption technology provides enterprises with more safe and secure connection and access. As shown in the figure, such structure is with a few servers, and the user end enters into a Skype application server 50 firstly to process the procedures of registration and log-in. In future, a contact list in the Skype application server 50 can be downloaded in order to acquire all presences. Each of the node of user ends 11 to 14 has the functions of communication terminal and server; further, because of the super nodes, such as S1, S2, S3, and S4, thus although the user end makes a call through the public Internet, Skype may find out a best and shortest path to deliver by means of packets so as to keep a good quality of communication and encryption. Nevertheless, such encryption technology with higher security causes another network management problem within an enterprise, so that individual employee access and cost can not be fully controlled.

Consequently, a gateway device converging SIP and Skype communications to achieve Unified Communication (UC) effects that has become a subject to be fulfilled.

Skype has the advantages that SIP is just not with, such as low cost, good communication quality, easy installment, so that lots of user ends adopt Skype in a very short time. Based on the situation, some related products or technologies are generated, and more applications will be developed in future.

Referring FIG. 5, which is a structure diagram of the iSkoot. As shown in the figure, iSkoot employs the Skype technology in the mobile phones. First, a Skype-like thin client is installed in the mobile phone 82, and then the user save the user account and password in the iSkoot server. It is necessary to store the group phone number in the server when log on Skype network through the server. When the user dials up, because the program in the installation process, a Public Swithed Telephone Network (PSTN) number of the iSkoot is saved, then the program will dial the number of the PSTN to the iSkoot platform, and send caller's identification code to the Internet phone—mobile phone gateway 72. Then the dialing is done according to the number corresponding to contact through the Public Switched Telephone Net—VoIP gateway 71.

Disadvantage of this approach would allow users to have to pay the cost of public switched telephone network, thus the features of Skype of cost-saving will loss. In addition, the program can be used only in the mobile phone with 2.5G, and the users must send their own Skype account information to the iSkoot platform to register. Personal account information and the log will be saved in the iSkoot, there will be privacy issues and security problem in the enterprise.

All Internet phone system tied up the purpose of saving-cost. Referring to FIG. 6, which is a structure diagram of jajah. As shown, jajah emphasize to a feature of talking by a web browser. First, the user 91 can log in the jajah server 90 through a computer or any device that can browse the web page, then buying points in the jajah server 90, and enter personal information and the default number, wherein the number is saved in the communication terminal 93. When the Caller 92 wants to communicate with Callee 94, the Caller 92 enter the number of the Callee 94 in the plateform, then the jajah server 90 dial the number preset by the Caller 92 and ring the communications terminal 93, when the Caller 92 connected later, jajah server 90 re-allocated to the Callee 94, finally the two sides talk to each other.

The shortcomings of the process include: it being able to be used in calling out and being use the public switched telephone network; the using cost being too high and the effect of cost-saving is not well; there being not any mechanism of enterprise representative number, thus it being not suitable for a enterprise; the problem of dialing-up conflict being able to be happen. If someone calls into the callee 94 or the caller 92, it will not be able to conduct two-way link. Set aside after the phone call may encounter busy, busy lines may also be diverted to voice mail while out of control, and then unnecessary payment. Users are more likely to cause trouble, and the user can not know exactly whether the phone was launched. In addition, this service model will not have presence display function.

If a kind of gateway devices can use Skype's advantage of calling back to the speaker side of, but also shows the representative number of the enterprise and makes the communication easier, it will become an urgent issue.

Because of the many benefits of Skype, the Skype application to the business side becomes very important. Gradually, gateways having Skype are introduced into the business side, but most can only provide to the enterprise representative number and can not be the personal representative number. For the current business environment, it is extremely important that the identification of the caller can be displayed and identified, and it cannot satisfy all the business applications by providing a group of business representative number.

In addition, when all the features of Skype are integrated into the gateway, phone functions (such as: call forwarding, call reservations, answer, etc.), conferencing, video telephony functions, cost effective functions can being deal with. This full-featured way will spend a lot of CPU, RAM and other system resources when multiple users simultaneously using the device. Through our selection of different types of communications with the terminal software, optimize resource use planning system so that the maximum communication capacity of the system is implemented. If it could be a kind of gateway devices constructed on Skype and can provide multiple service levels to achieve the Light-weight purpose, different cost-saving policy can be set according to different users, and the representative numbers and personal numbers can be shown, and employing the system in a enterprise is an urgent issues.

### SUMMARY OF THE INVENTION

The main objective of the present invention is to provide a network communication system for supporting multiple network protocols and a method for controlling the same, which improves the conventional gateways and provides the function of presence of the gateways to the users. The system of the present invention also can represent the numbers of individual user ends and the representative numbers of the enterprise ends, and all the users of the enterprise can maintain the online presence at the same time through the system of the present invention.

According to the above object, the present invention provides a network communication system for supporting non-specific network protocols comprising: a network channel interface, delivering and acquiring the signals of network packets; a network communication terminal module, processing network voice communications and at least comprising: a personal network communication module, processing the ID information of the employees of the enterprise ends; an enterprise network communication module, processing the ID information of the enterprise ends; a core intermediate module, controlling and processing the signals of the network communication system, providing received data, processed data and delivered presence data, selecting audio channels, giving channel signal commands and parameters, processing the codes and decodes of the streams of audio signals, and proceeding the process of feed-in and feed-out; and an audio channel exchanging module, building up, processing and maintaining the audio signals, and further detecting, filtering and generating telecommunication signals supported by hardware interfaces.

Another objective of the present invention is to provide a network communication system for supporting multiple network protocols and a method for controlling the same, integrating presences in gateways and being as an exchanging mechanism among enterprise ends and external communications so as to log in for confirming presences via Internet browsers for representing the numbers of individual user ends and the representative numbers of the enterprise ends. When logging in the present system by using a computer or other device which can use a web page explore, the user can maintain the online present or adjust to any status so as to avoid the status, such as busy, logging out temporarily and hide, being not known by other people.

According to the above object, the present invention provide a network communication system for supporting non-specific network protocols comprising: a network channel interface, delivering and acquiring the signals of network packets; a network communication terminal module, processing Network voice communications and at least comprising: a personal network communication module, processing the ID information of the employees of the enterprise ends; an enterprise network communication module, processing the ID information of the enterprise ends; a core intermediate module, controlling and processing the signals of the network communication system, providing received data, processed data and delivered presence data, selecting audio channels, giving channel signal commands and parameters, and processing the codes and decodes of the streams of audio signals, and proceeding the process of feed-in and feed-out; an Internet server, delivering and acquiring a message and a control signal, acquiring all log-in demands, and communicating with the personal network communication module and the enterprise network communication module; a database, storing the confirmations of the log-ins of user ends, authorization information, policy tables, and the authorization and confirmation information in the network communication terminal module; and an audio channel exchanging module, building up, processing and maintaining the audio signals, and further detecting, filtering and generating telecommunication signals supported by hardware interfaces.

Further objective of the present invention is to provide a network communication system for supporting multiple network protocols and a method for controlling the same, which dissolve the problem of that the conventional integral communication all can not communicate with Skype, and is achieved through a device. The present system employs a multiple communication way in gateways in order to make enterprise ends easily manage the communications thereof and approach the effect of unifying communications, and the numbers of individual user ends and the representative numbers of the enterprise ends being shown. No matter what kind of internet communication process, such as Skype, MSN, Yahoo messenger, and Google Talk, is used by the users, the present system can be used to switch the communication between different programs, and all the communication type, such as audio, multi-media, telephone, words, and files, can be used, so as to integrate the unified communications (UC) in the gateways completely.

According to the above object, the present invention provide a network communication system for supporting non-specific network protocols comprising: a network channel interface, delivering and acquiring the signals of network packets; a network communication terminal module, processing Network voice communications and at least comprising: a personal network communication module, processing the ID information of the employees of the enterprise ends; an enterprise network communication module, processing the ID information of the enterprise ends; a core intermediate module, controlling and processing the signals of the network communication system, processing the codes and decodes of the streams of audio signals, and proceeding the process of feed-in and feed-out, comprising: a control signal unit, selecting audio channels, giving channel signal commands and parameters; a presence unit, acquiring, processing and delivering presence data acquired by the network communication terminal module, wherein the presence data are translated and delivered out; an instant message relay unit, acquiring instant messages from the network communication terminal module, wherein the instant messages are translated and delivered out; a representative log-in unit, switching log-in information in the system stored by the user ends to different accounts to replace the operations of the user ends; an Internet server, delivering and acquiring a message and a control signal, acquiring all log-in demands, and communicating with the personal network communication module and the enterprise network communication module, delivering instant messages to the instant message relay unit, the instant messages being translated and delivered out by the instant message relay unit after the instant message relay unit acquires the instant messages; a database, storing the confirmations of the log-ins of user ends, authorization information, policy tables, and the authorization and confirmation information in the personal network communication module and the enterprise network communication module; and an audio channel exchanging module, building up, processing and maintaining the audio signals, and further detecting, filtering and generating telecommunication signals supported by hardware interfaces, the control signal unit ordering the audio channel exchanging module.

Further objective of the present invention is to provide a network communication system for supporting multiple network protocols and a method for controlling the same, which employ the conventional Skype in the gateways of the enterprise and makes enterprise ends easily manage the communications of the Skype, and the numbers of individual user ends and the representative numbers of the enterprise can be shown in the enterprise ends. Introducing the characteristics of Skype, such as good communication quality and the way to save cost is clear and definite, into the enterprise ends can make the enterprise save telephone bill and cost remarkably, and the talking time and the telephone bill of the employees can be monitored and managed. The present invention uses a specific manner of callback and differentiates between an initiation end, a speaking end and an answer end much clearly, wherein the initiation end can select the number and the dialing mode of the speaking end according to different policy and can select the number and the communication mode of the answer end so as to make the communication more flexible. The initiation end can initiate a call without having an internet telephone, thus the convenience of the communication can be elevated greatly.

According to the above object, the present invention provide a network communication system for supporting non-specific network protocols comprising: a network channel interface, delivering and acquiring the signals of network packets; a network communication terminal module, processing Network voice communications and at least comprising: a personal network communication module, processing the ID information of the employees of the enterprise ends; an enterprise network communication module, processing the ID information of the enterprise ends; a core intermediate module, controlling and processing the signals of the network communication system, processing the codes and decodes of the streams of audio signals, and proceeding the process of feed-in and feed-out, comprising: a control signal unit, selecting audio channels, giving channel signal commands and parameters; a presence unit, acquiring, processing and delivering presence data acquired by the network communication terminal module, wherein the presence data are translated and delivered out; an instant message relay unit, acquiring instant messages from the network communication terminal module, wherein the instant messages are translated and delivered out; an Internet server, delivering and acquiring a message and a control signal, acquiring all log-in demands, and communicating with the network communication terminal module, delivering instant messages to the instant message relay unit, the instant messages being translated and delivered out by the instant message relay unit after the instant message relay unit acquires the instant messages; a database, storing the confirmations of the log-ins of user ends, authorization information, policy tables, and the authorization and confirmation information in the network communication terminal module; and an audio channel exchanging module, building up, processing and maintaining the audio signals, and further detecting, filtering and generating telecommunication signals supported by hardware interfaces, the control signal unit ordering the audio channel exchanging module.

Further objective of the present invention is to provide a network communication system for supporting multiple network protocols and a method for controlling the same, which employs a Skype way in gateways in order to make enterprise ends easily manage the communications of the Skype and approach features of light-weight and high-flexibility, and the numbers of individual user ends and the representative numbers of the enterprise ends being shown, wherein at least two terminal module are used to treat different works, and a dynamic distribution can achieve the policies of paying optimum telephone bill of different levels, personal special line and functional limitation so as to increase the system volume greatly and decrease the cost.

According to the above object, the present invention provide a network communication system for supporting non-specific network protocols comprising: a network channel interface, delivering and acquiring the signals of network packets; a network communication terminal module, processing Network voice communications and at least comprising: a personal network communication module, processing the ID information of the employees of the enterprise ends; an enterprise network communication module, processing the ID information of the enterprise ends, at least comprising two terminal modules for providing multiple service levels and dynamic configurations, wherein the two terminal modules are a first terminal module (Micro) and a second terminal module (Normal); a core intermediate module, controlling and processing the signals of the network communication system, processing the codes and decodes of the streams of audio signals, and proceeding the process of feed-in and feed-out, comprising: a control signal unit, selecting audio channels, giving channel signal commands and parameters; a presence unit, acquiring, processing and delivering presence data acquired by the network communication terminal module, wherein the presence data are translated and delivered out; an instant message relay unit, acquiring instant messages from the network communication terminal module, wherein the instant messages are translated and delivered out; an Internet server, delivering and acquiring a message and a control signal, acquiring all log-in demands, and communicating with the network communication terminal module, delivering instant messages to the instant message relay unit, the instant messages being translated and delivered out by the instant message relay unit after the instant message relay unit acquires the instant messages; a database, storing the confirmations of the log-ins of user ends, authorization information, policy tables, and the authorization and confirmation information in the network communication terminal module; and an audio channel exchanging module, building up, processing and maintaining the audio signals, and further detecting, filtering and generating telecommunication signals supported by hardware interfaces, the control signal unit ordering the audio channel exchanging module

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view showing a conventional gateway structure;

FIG. 2 illustrates a schematic structure of the Unified Communication (UC) deployment;

FIG. 3 illustrates a schematic view of Microsoft Office Communications Server (MS OCS) deployment to a SIP-based environment;

FIG. 4 illustrates a schematic structure of a Skype application;

FIG. 5 illustrates a schematic structure diagram of iSkoot;

FIG. 6 illustrate a schematic structure diagram of jajah;

FIG. 7 illustrates a schematic view of a structure of a first preferred embodiment of the network communication system for supporting non-specific network protocols of the present invention of the present invention;

FIG. 8A and FIG. 8B illustrate a call-in flow chart of the first preferred embodiment of the network communication method for supporting the non-specific network protocols of the present invention;

FIG. 9 illustrates a call-out flow chart of the first preferred embodiment of the network communication method for supporting the non-specific network protocols of the present invention;

FIG. 10 illustrates a schematic view of a structure of a second preferred embodiment of the network communication system for supporting non-specific network protocols of the present invention of the present invention;

FIG. 11A and FIG. 11B illustrate a call-out flow chart of the second preferred embodiment of the network communication method for supporting the non-specific network protocols of the present invention;

FIG. 12 illustrates a schematic view of a structure of a third preferred embodiment of the network communication system for supporting non-specific network protocols of the present invention of the present invention;

FIG. 13A and FIG. 13G illustrate a call-in flow chart of the third preferred embodiment of the network communication method for supporting the non-specific network protocols of the present invention;

FIG. 14 illustrates a schematic view of a structure of a fourth preferred embodiment of the network communication system for supporting non-specific network protocols of the present invention of the present invention;

FIG. 15 illustrates a call-in flow chart of the fourth preferred embodiment of the network communication method for supporting the non-specific network protocols of the present invention;

FIG. 16A to FIG. 16F illustrate a call-in flow chart of the third preferred embodiment of the network communication method for supporting the non-specific network protocols of the present invention;

FIG. 17 illustrates a schematic view of a structure of a fifth preferred embodiment of the network communication system for supporting the non-specific network protocols of the present invention of the present invention;

FIG. 18A to FIG. 18E illustrate a flow chart of the fourth preferred embodiment of the network communication method for supporting the non-specific network protocols of the present invention; and

FIG. 19A to FIG. 19D illustrate a call-out flow chart of the first preferred embodiment of the network communication method for supporting the non-specific network protocols of the present invention.

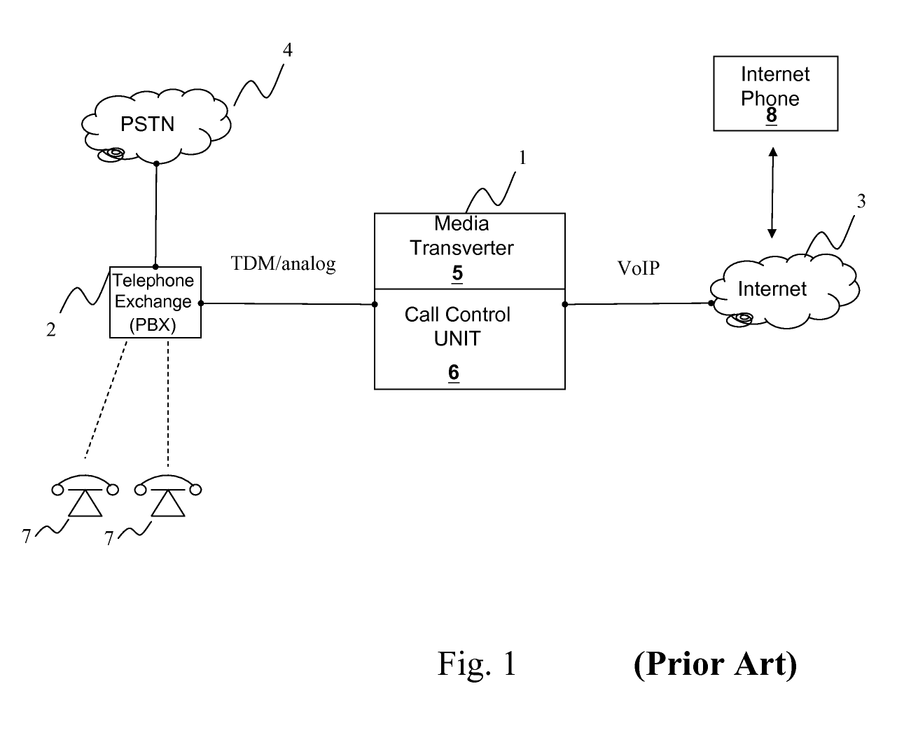

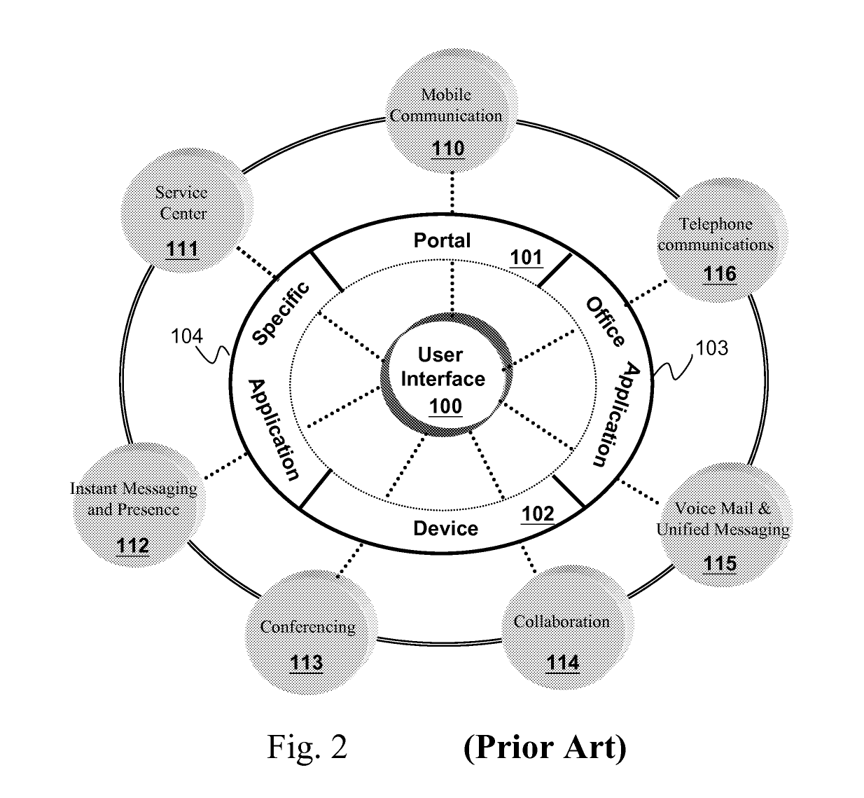

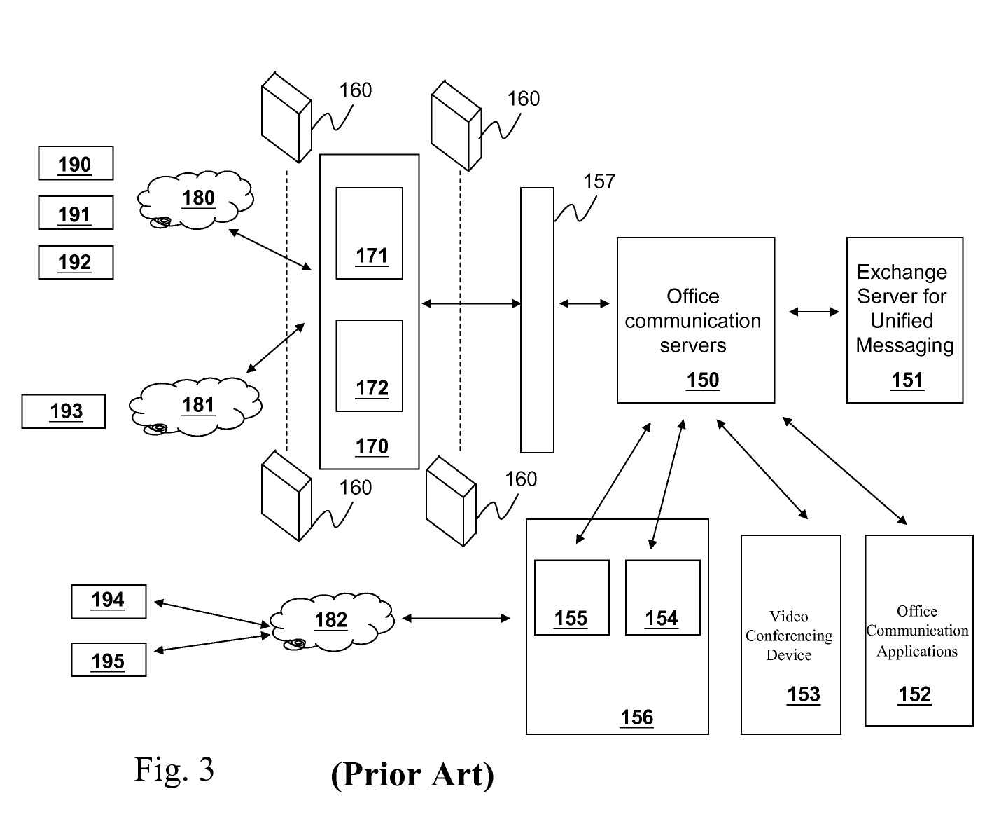

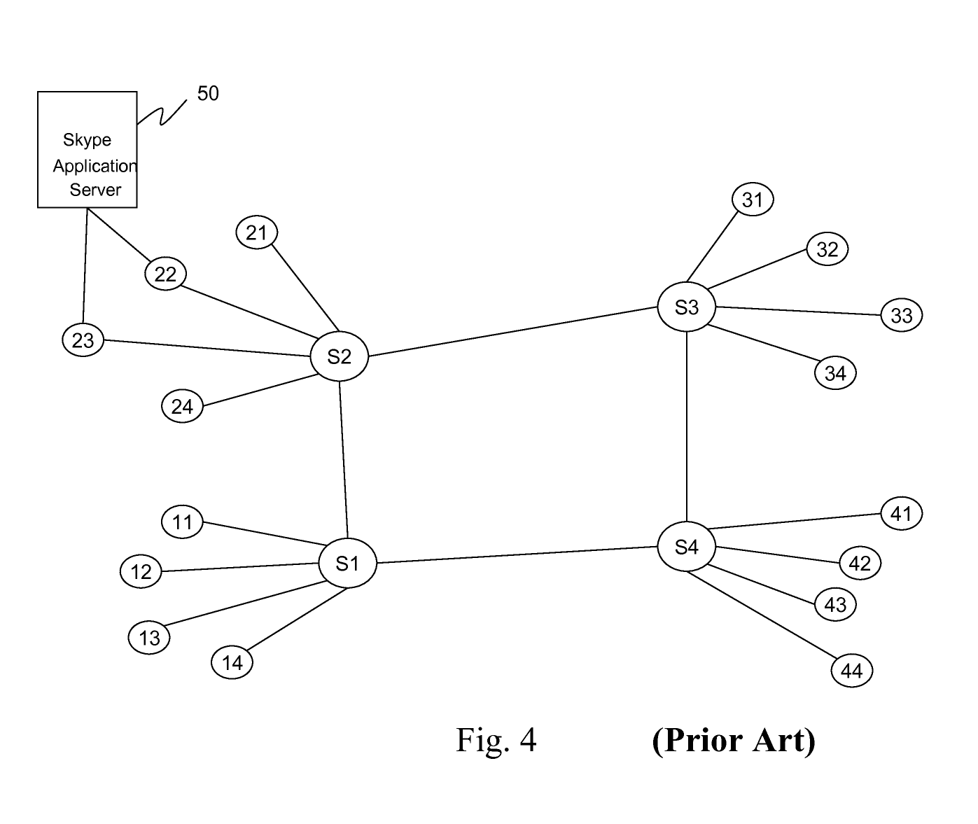

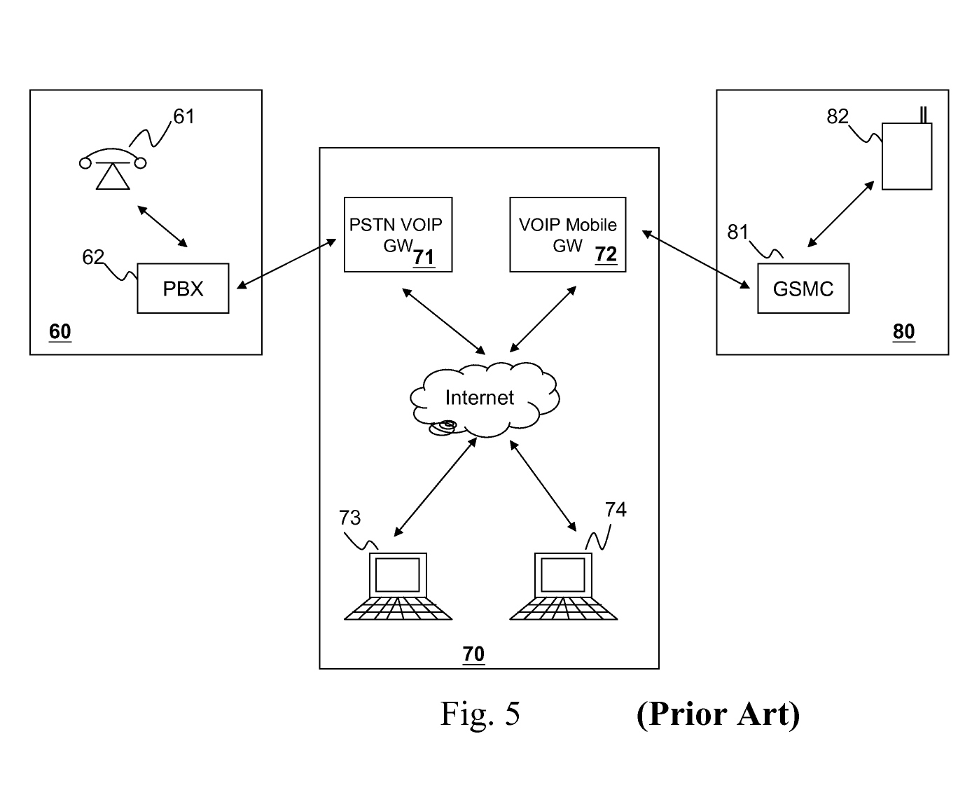

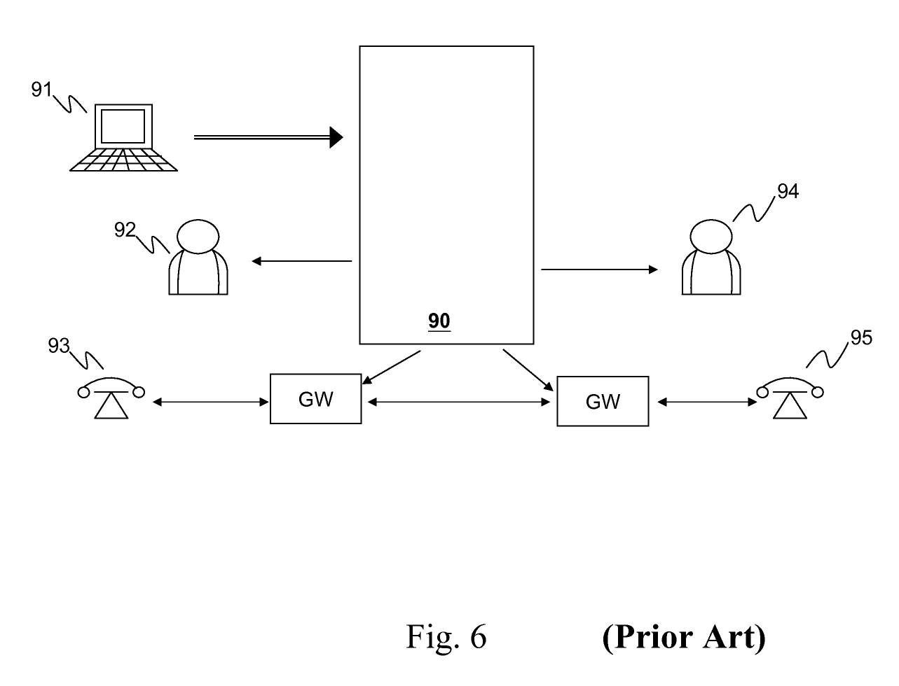

### DETAILED DESCRIPTION OF THE INVENTION

Following preferred embodiments and figures will be described in detail so as to achieve aforesaid objects.

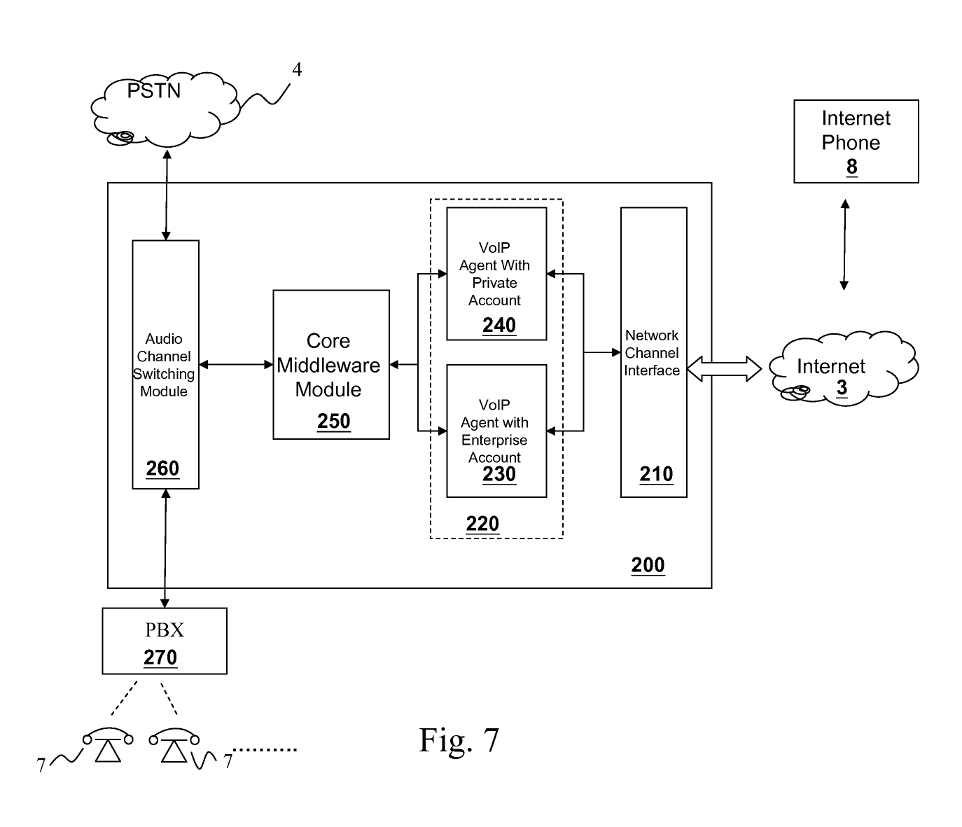

With reference to FIG. 7, which illustrates a schematic view of a structure of a first preferred embodiment of the network communication system for supporting non-specific network protocols of the present invention. The system integrates presences in gateways and is as an exchanging mechanism among enterprise ends and external communications so as to represent the numbers of individual user ends and the representative numbers of the enterprise ends. As shown in the figure, the system 200 includes a network channel interface 210, a network communication terminal module 220, a core intermediate module 250, and an audio channel exchanging module 260; further, the communications of the enterprise end can be done by an exchanging mechanism 270. The details are as that of:

the network channel interface 210, delivering and acquiring the signals of network packets, wherein the network channel interface at least comprises: a transmission control protocol (TCP) and a user datagram protocol (UDP);
the network communication terminal module 220, processing network voice communications and at least comprising: a personal network communication module 240, processing the ID information of the employees of the enterprise ends; and an enterprise network communication module 230, processing the ID information of the enterprise ends;
wherein the numbers of individual user ends and the representative numbers of the enterprise ends can be shown through the enterprise network communication module 230 and the personal network communication module 240, processing the ID information of the employees of the enterprise ends;
the core intermediate module 250, controlling and processing the signals of the network communication system 200, providing received data, processed data and delivered presence data, selecting audio channels, giving channel signal commands and parameters, processing the codes and decodes of the streams of audio signals, and proceeding the process of feed-in and feed-out; and
the audio channel exchanging module 260, building up, processing and maintaining the audio signals, and further detecting, filtering and generating telecommunication signals supported by hardware interfaces, wherein the audio channel exchanging module at least comprises: a session initiation protocol (SIP), an E1/T1 interface, a foreign eXchange station (FXS), and a foreign eXchange office (FXO).
FIG. 7 is an embodiment for calling in, and will be described as follows:
The account of an employee is listed on a personal contact list and has a corresponding extension number, shown as following:

| | | corresponding extension |
|---|---|---|
| Name | Account | number |
| Tony | Employee 1 | 120 |

While an external call is calling employee 1, the core intermediate module 250 delivers the DID (Direct Inward Dialing) signal of the message of transferring to the extension number 120 to the switching mechanism 270 through the audio channel exchanging module 260, the extension number 120 or the switching mechanism 270 is being ringed directly, a DTMF signal 100 is then sent out after the switching mechanism 270 answers, that is, a request to transferring to the extension number 100 is thus given.
Further, the enterprise network communication module 230 has a representative number of the enterprise end, which is corp1, such representative number can be more based on demands. While an external call to corp1 is made, the core intermediate module 250 directly rings at the exchanging mechanism 270 through the adult channel exchanging module 260. The exchanging mechanism 270 answers the call and then requests the caller to input an extension number. After the exchanging mechanism 270 acquires the extension number of the DTMF signal, the call is being transferred an extension phone 7.

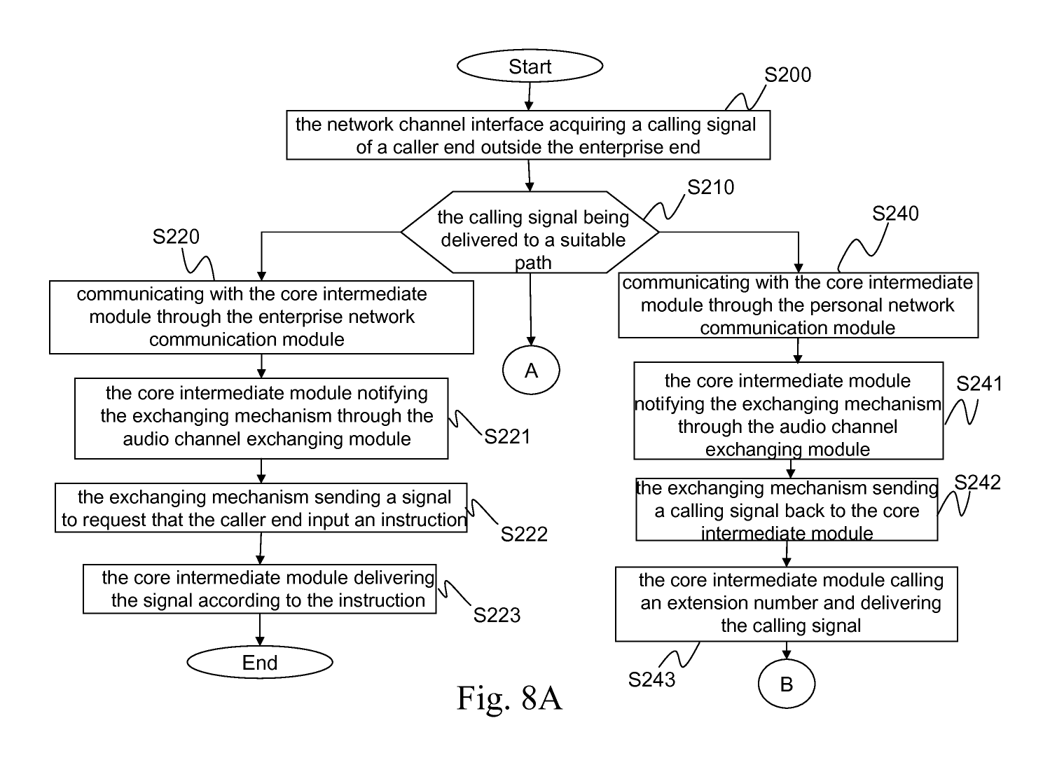

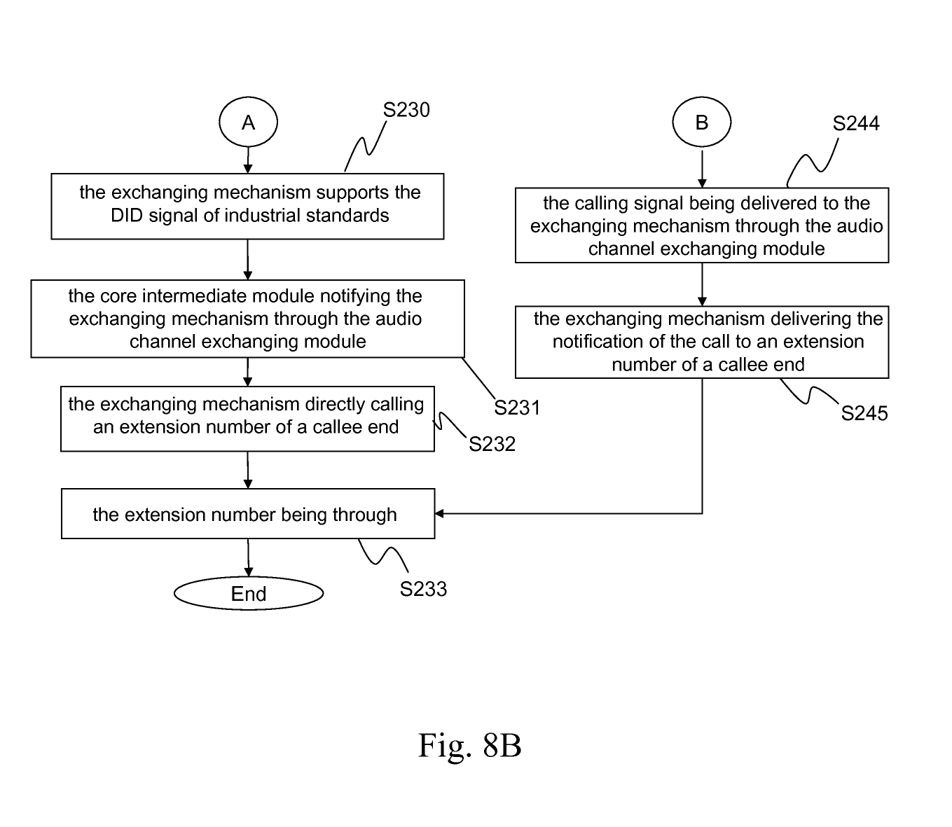

Through the system, the number of an individual user end of the representative number of an enterprise end can be shown. While the system is in operations, the presence can be as that of all user ends of the enterprise end being on-line simultaneously. With reference to FIG. 8A and FIG. 8B, which illustrate a call-in flow chart of the first preferred embodiment of the network communication method for supporting the non-specific network protocols of the present invention. The flow chart includes the steps of: the network channel interface 210 acquiring a calling signal of a caller end outside the enterprise end (S200); the calling signal being delivered to a suitable path (S210); wherein the suitable path has three ways and the first way is traditional, communicating with the core intermediate module 250 through the enterprise network communication module 230 (S220); the core intermediate module 250 notifying the exchanging mechanism 270 through the audio channel exchanging module 260 (S221); the exchanging mechanism 270 sending a signal to request that the caller end input an instruction (S222); an automatic telephone exchanging system sending out a voice request in order to let the user end input, the core intermediate module 250 delivering the signal according to the instruction (S223).

The second way is that of: communicating with the core intermediate module 250 through the personal network communication module 240, wherein the exchanging mechanism 270 supports the DID signal of industrial standards (S230); the core intermediate module 250 notifying the exchanging mechanism 270 through the audio channel exchanging module 260 according to the telephone signal and the DID signal (S231); the exchanging mechanism 270 directly calling an extension number of a callee end (S232); and the extension number being through (S233). The flow is more convenient.
The third way is that of: communicating with the core intermediate module 250 through the personal network communication module 240, wherein the exchanging mechanism 270 cannot support the DID signal of industrial standards (S240); the core intermediate module 250 notifying the exchanging mechanism 270 through the audio channel exchanging module 260 (S241); the exchanging mechanism 270 sending a calling signal back to the core intermediate module 250 (S42); after acquiring the calling signal, the core intermediate module 250 calling an extension number and delivering the calling signal (S243); the calling signal being delivered to the exchanging mechanism 270 through the audio channel exchanging module 260 (S244); the exchanging mechanism 270 delivering the notification of the call to an extension number of a callee end (S245); and then going to (S233).

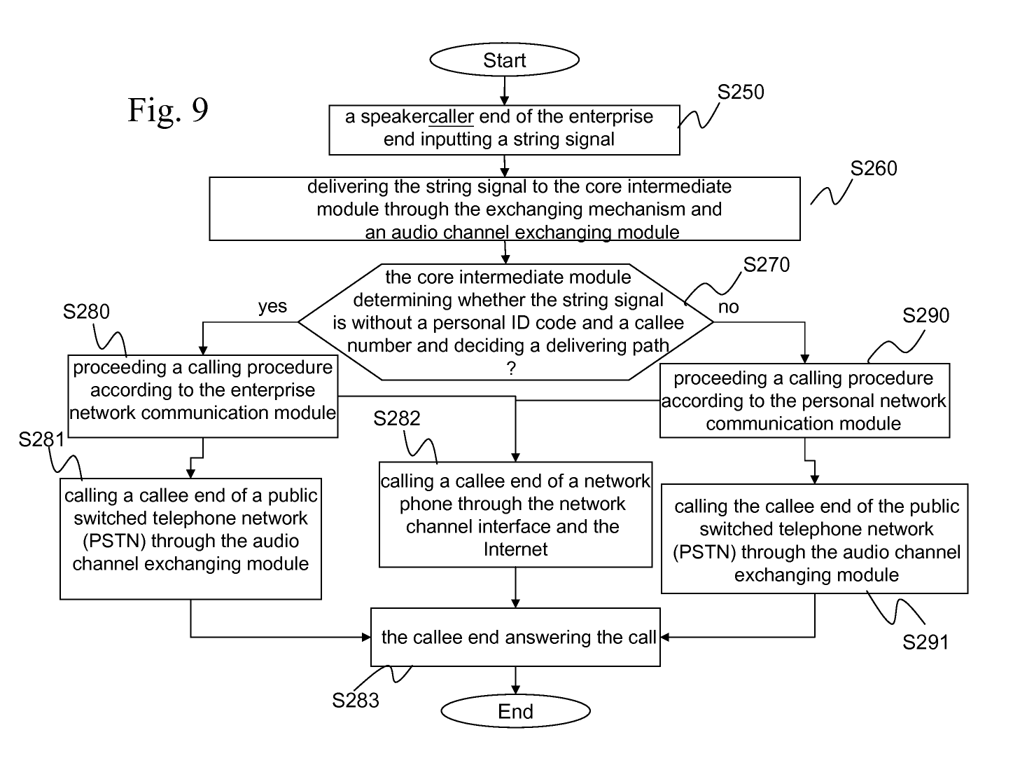

With reference to FIG. 9, which illustrates a call-out flow chart of the first preferred embodiment of the network communication method for supporting non-specific network protocols of the present invention. The descriptions to FIG. 9 includes the steps of:

a caller end of the enterprise end inputting a string signal, wherein the string signal is an assembly of a plurality of numbers, symbols and characters (S250); delivering the string signal to the core intermediate module 250 through the exchanging mechanism 270 and an audio channel exchanging module 260 (S260); the core intermediate module 250 determining whether the string signal is without a personal ID code and a callee number, and deciding a delivering path (S270); if yes, proceeding a calling procedure according to the enterprise network communication module 230 (S280); calling a callee end of a public switched telephone network (PSTN) through the audio channel exchanging module 260 (S281); and the callee end answering the call (S283); or, calling a callee end of a network phone through the network channel interface 210 and the Internet; if no, proceeding a calling procedure according to the personal network communication module 220 (S290); calling the callee end of the public switched telephone network (PSTN) through the audio channel exchanging module 260, and the callee end answering the call (S283); or calling a callee end of a network phone through the network channel interface 210 and the Internet (S282); and the callee end answering the call (S283). According to above mentions, the ways are able to call the callee end of the public switched telephone network (PSTN) or the voice over Internet protocol (VOIP) respectively.

Following is a detail description of call out of FIG. 9 of the first preferred embodiment:

a hunting group number of the exchanging mechanism 270 is 5, the ID number of the employee Tony is 100. The contact list of Tony is as following:

| | Corresponding callee end code |
|---|---|
| Private Contact ID | or speed-dial code |
| friend1 | 11 |
| friend2 | 12 |
| friend3 | 13 |

The public contact list of the module of the enterprise is as following:

| | Corresponding speed-dial code |
|---|---|
| Public Contact ID | (callee end code) |
| bizpart1 | 601 |
| bizpart2 | 602 |

When the user end calls a friend whose PSTN number is 0933-708401 from the enterprise end, the possible ways for calling out are as follows of:
1. 5->10011: Picking up a telephone (off-hook) and dialing “5” to request the exchanging mechanism 270 for acquiring specific group ports, then dialing 10011, the audio channel exchanging module 260 detecting and filtering the signals of dialing 10011, the signals being delivered to the core intermediate module 250 for identification, the first three codes 100 being defined as the personal ID code of the employee Tony, further to know the friend1 corresponding to the two codes “11”, the core intermediate module 250 then sending out an instruction to the personal network communication module 240 in order to request the personal account of employee1 to call out friend1, if friend1 is on line and supports the function of “caller ID”, then the call from employee1 being shown.
2. 5->100 0933708401: Picking up a telephone (off-hook) and dialing “5” to request the exchanging mechanism 270 for acquiring specific group ports, then dialing 100 0933708401, the audio channel exchanging module 260 detecting and filtering the signals of dialing 100 0933708401, the signals being delivered to the core intermediate module 250 for identification, the first three codes 100 being defined as the personal ID code of the employee Tony, other codes 0933708401 being not found from the speed-dial codes of the personal contact list and then defined as a PSTN number, thus based on the priority of a cost-saving program, the core intermediate module 250 then selectively sending out an instruction to the personal network communication module 240 in order to request the personal account of employee1 to call out 0933708401 of the cost-saving program, or sending out an instruction to the audio channel exchanging module 260 to call out 0933708401 via the PSTN.

3. 5->601: Picking up a telephone (off-hook) and dialing “5” to request the exchanging mechanism 270 for acquiring specific group ports, then dialing 601, the audio channel exchanging module 260 detecting and filtering the signals of dialing 601, the signals being delivered to the core intermediate module 250 for identification, the codes of 601 being in the public contact list, the core intermediate module 250 then sending out an instruction to the enterprise network communication module 230 in order to request the enterprise representative number of corp1 to call out bizpartl, if bizpartl is on line and supports the function of “caller ID”, then the call from corp1 being shown.
4. 5->0933708401: Picking up a telephone (off-hook) and dialing “5” to request the exchanging mechanism 270 for acquiring specific group ports, then dialing 0933708401, the audio channel exchanging module 260 detecting and filtering the signals of dialing 0933708401, the codes 0933708401 being defined as a PSTN number, thus based on the priority of the cost-saving program, the core intermediate module 250 then selectively sending out an instruction to the enterprise network communication module 230 in order to request the enterprise representative number of corp1 to call out 0933708401 of the cost-saving program, or sending out an instruction to the audio channel exchanging module 260 to call out 0933708401 via the PSTN.

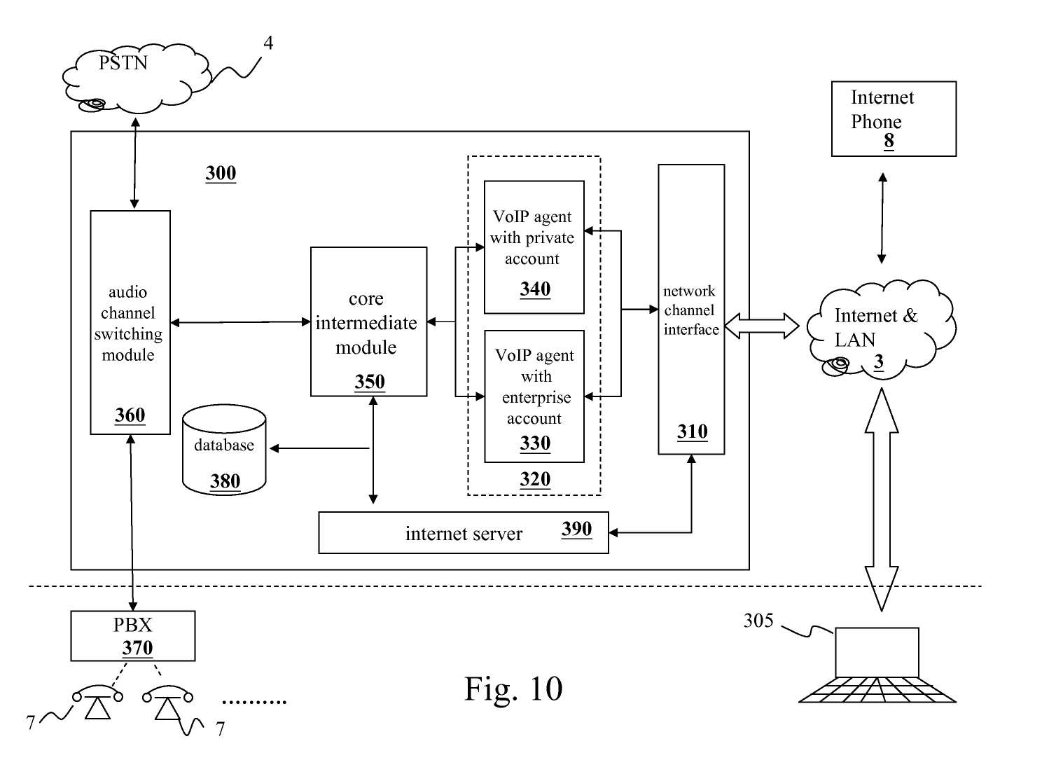

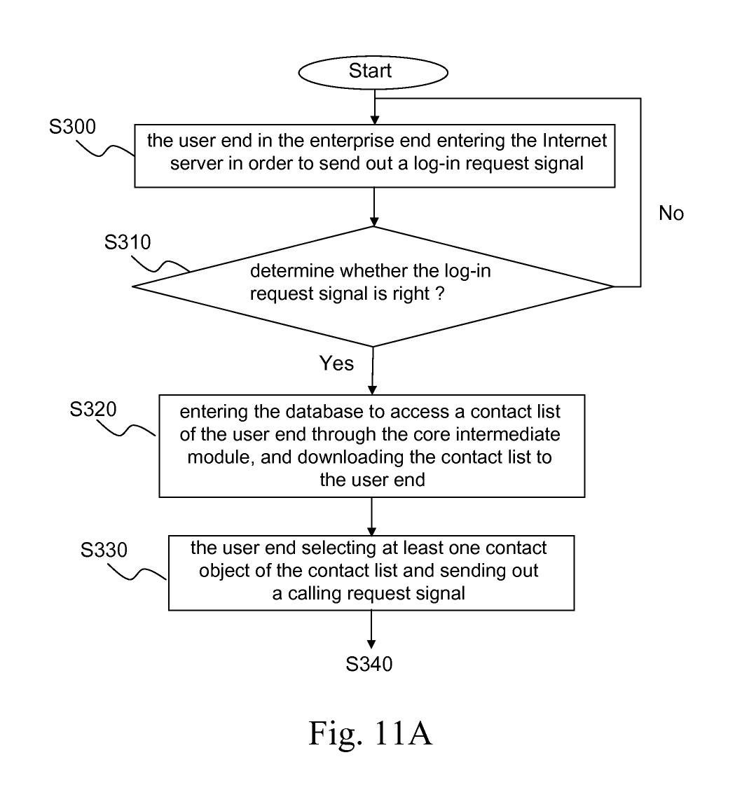

With reference to FIG. 10, which illustrates a schematic view of a structure of a second preferred embodiment of the network communication system for supporting non-specific network protocols of the present invention. The system integrates presences in gateways and is as an exchanging mechanism among enterprise ends and external communications so as to log in for confirming presences via Internet browsers for representing the numbers of individual user ends and the representative numbers of the enterprise ends. As shown in the figure, the system 300 includes a network channel interface 310, a network communication terminal module 320, a core intermediate module 350, an audio channel exchanging module 360, an Internet server 380, and a database 390; further, the communications of the enterprise end can be done by an exchanging mechanism 370. The details are as that of:

the network channel interface 310, delivering and acquiring the signals of network packets, wherein the network channel interface at least comprises: a transmission control protocol (TCP) and a user datagram protocol (UDP);
the network communication terminal module 320, processing network voice communications and at least comprising: a personal network communication module 340, processing the ID information of the employees of the enterprise ends; and an enterprise network communication module 330, processing the ID information of the enterprise ends;
wherein the numbers of individual user ends and the representative numbers of the enterprise ends can be shown through the enterprise network communication module 330 and the personal network communication module 340, processing the ID information of the employees of the enterprise ends;
the core intermediate module 350, controlling and processing the signals of the network communication system 300, providing received data, processed data and delivered presence data, selecting audio channels, giving channel signal commands and parameters, processing the codes and decodes of the streams of audio signals, and proceeding the process of feed-in and feed-out;
the audio channel exchanging module 360, building up, processing and maintaining the audio signals, and further detecting, filtering and generating telecommunication signals supported by hardware interfaces, wherein the audio channel exchanging module at least comprises: a session initiation protocol (SIP), an E1/T1 interface, a foreign eXchange station (FXS), and a foreign eXchange office (FXO);
the Internet server 380, delivering and acquiring a message and a control signal, acquiring all log-in demands, and communicating with the network communication terminal module; and
the database 390, storing the confirmations of the log-ins of user ends, authorization information, policy tables, and the authorization and confirmation information in the personal network communication module and the enterprise network communication module.
Comparing the second preferred embodiment in FIG. 10 to the first preferred embodiment in FIG. 7, the second preferred embodiment is that of the data of a delivering presence being presented after log-in, that is, the working presence of the employees may be shown up in time. Therefore, there is no application for calling provided.

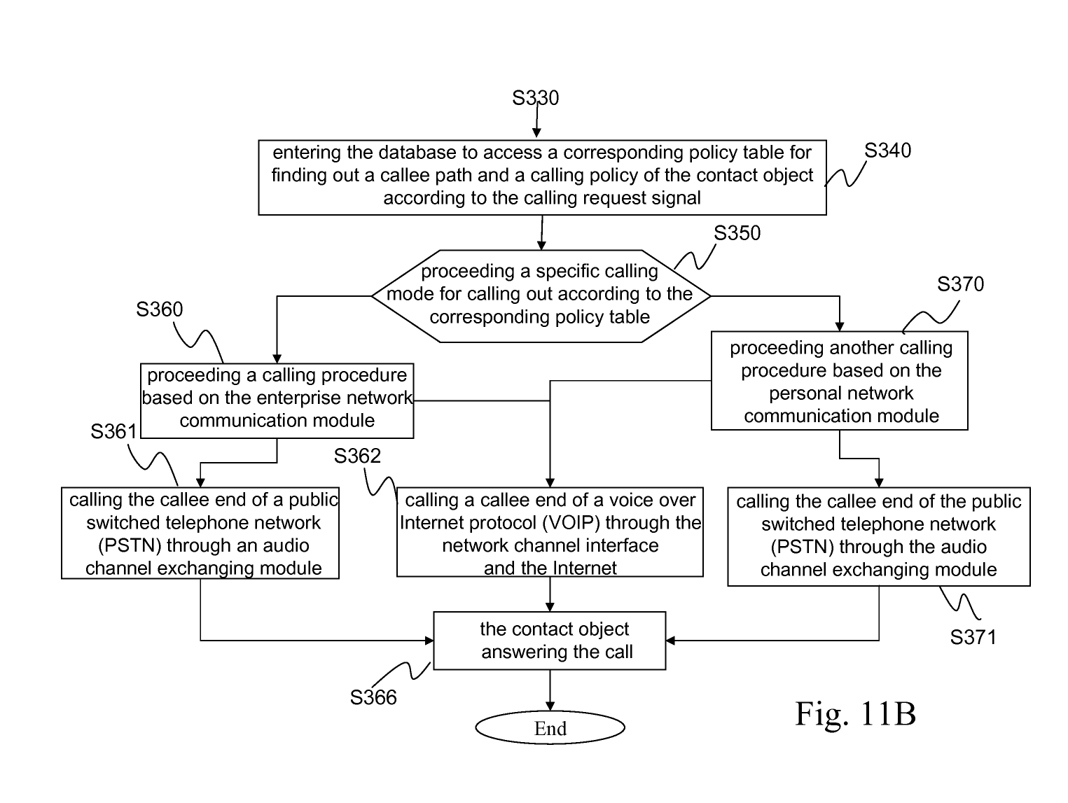

By means of the system, the number of an individual user end or the representative number of the enterprise end can be presented while calling out. When the user end operates a computer 305 or other devices with browsers to log in the Internet via the Internet server 380, the user end can be in the presence of on-line for other user ends knowing what the user end is in the presence of on-line or avoiding that the user end switches to other presences. For more detail, please refer to FIG. 11A and FIG. 11B, which illustrate a call-out flow chart of the second preferred embodiment of the network communication method for supporting the non-specific network protocols of the present invention. The descriptions to FIG. 11A and FIG. 11B are as of:

the user end in the enterprise end entering the Internet server 390 in order to send out a log-in request signal (S300); entering the database 380 to access data through the Internet server 390 in order to determine whether the log-in request signal is right (S310); if no, going back to (S300), if yes, entering the database 380 to access a contact list of the user end through the core intermediate module 350, and downloading the contact list to the user end, wherein the user end can be the computer 305 or other devices with browsers (S320); the user end selecting at least one contact object of the contact list and sending out a calling request signal (S330); referring to FIG. 11B, through the core intermediate module 350, entering the database 380 to access a corresponding policy table for finding out a callee path and a calling policy of the contact object according to the calling request signal (S340); proceeding a specific calling mode for calling out according to the corresponding policy table (S350), wherein (S350) further comprises the steps of: proceeding a calling procedure based on the enterprise network communication module 330 (S360) and proceeding another calling procedure based on the personal network communication module 320 (S370); after (S360), calling the callee end of a public switched telephone network (PSTN) through an audio channel exchanging module 360 (S361); and the contact object answering the call; or calling a callee end of a voice over Internet protocol (VOIP) through the network channel interface and the Internet (S362); and the contact object answering the call.
After (S370), calling the callee end of the public switched telephone network (PSTN) through the audio channel exchanging module 360 (S371); and the contact object answering the call (S366); or calling the callee end of the voice over Internet protocol (VOIP) through a network channel interface 310 and the Internet (S362); and the contact object answering the call (S366).
According to the first and second preferred embodiments, the second preferred embodiment needs the device with a browser to log in the system via a network. Thus, the user end is with the function of presence, through some settings, the user end can call out via an enterprise representative number or a personal number. The first preferred embodiment is that of the user end being in the presence of on-line while in operations in the system, and the user end is able to use a personal ID code to decide using an enterprise representative number or a personal number for calling out. Adding the function of presence in a gateway is flexible to select the ways of calling out so as to let the callee end know who is calling. Hence, the operation flexibility of an enterprise is raised.

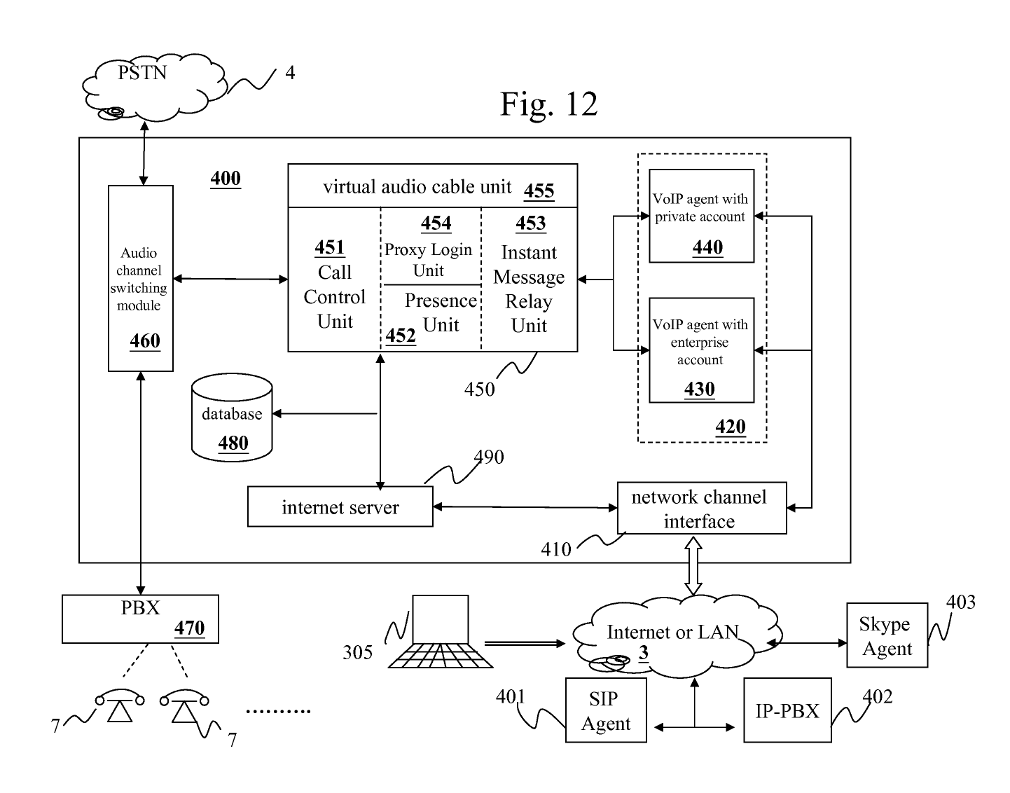

With reference to FIG. 12, which illustrates a schematic view of a structure of a third preferred embodiment of the network communication system for supporting non-specific network protocols of the present invention of the present invention. The third preferred embodiment is to figure out the problem that the present integrated communications cannot be compatible with Skype. That is, adding a device can approach the solution to the problem. The system is applied to a multiple communication way in gateways in order to make enterprise ends easily manage the communications thereof and approach the effect of unifying communications, and the numbers of individual user ends and the representative numbers of the enterprise ends are shown. As shown in the figure, the system 400 includes a network channel interface 410, a network communication terminal module 420, a core intermediate module 450, an audio channel exchanging module 460, an Internet server 480, and a database 490; further, through an exchanging mechanism 470, the extension numbers of an enterprise can be through. Through the exchanging mechanism 470, an SIP account can be through either. By means of an SIP agent 401, an SIP account can be communicated with, or through a Skype agent 403, a Skype account can be communicated with as well. For more detail, the descriptions are as that of:

the network channel interface 410, delivering and acquiring the signals of network packets, wherein the network channel interface at least comprises: a transmission control protocol (TCP) and a user datagram protocol (UDP); the network communication terminal module 420, processing network voice communications and at least comprising: a personal network communication module 440, processing the ID information of the employees of the enterprise ends; and an enterprise network communication module 430, processing the ID information of the enterprise ends; wherein the numbers of individual user ends and the representative numbers of the enterprise ends can be shown through the enterprise network communication module 430 and the personal network communication module 440; a core intermediate module 450, controlling and processing the signals of the network communication system, processing the codes and decodes of the streams of audio signals, and proceeding the process of feed-in and feed-out, comprising: a control signal unit 451, selecting audio channels, giving channel signal commands and parameters;
a presence unit 452, acquiring, processing and delivering presence data acquired by the network communication terminal module, wherein the presence data are translated and delivered out;
an instant message relay unit 453, acquiring instant messages from the network communication terminal module, wherein the instant messages are translated and delivered out; a representative log-in unit 454, switching log-in information in the system stored by the user ends to different accounts to replace the operations of the user ends; and an audio channel exchanging module 460, building up, processing and maintaining the audio signals, and further detecting, filtering and generating telecommunication signals supported by hardware interfaces, the control signal unit ordering the audio channel exchanging module, wherein the audio channel exchanging module at least comprises: a session initiation protocol (SIP), an E1/T1 interface, a foreign eXchange station (FXS), and a foreign eXchange office (FXO); an Internet server 480, delivering and acquiring a message and a control signal, acquiring all log-in demands, and communicating with the network communication terminal module, delivering instant messages to the instant message relay unit, the instant messages being translated and delivered out by the instant message relay unit after the instant message relay unit acquires the instant messages; and a database 490, storing the confirmations of the log-ins of user ends, authorization information, policy tables, and the authorization and confirmation information in the network communication terminal module.

Through the representative log-in unit 454, no matter any network communication program as Skype, MSN, Yahoo messenger, Google Talk, etc., the system can easily switch the communications among aforesaid network communication programs. Further, the communications for voice, multimedia, telephone, character, file, etc. are involved as well. That is, unified communications are totally applied in gateways.

With reference to FIG. 12, an operation description for the calling out is as follow:

Log-in account and password: tony/tonypwd
Log-in account of communicated agent: IM or SIP account table

| | account | password |
|---|---|---|
| Skype | tonyskype | tonyskypepwd |
| MSN | tonymsn | tonymsnpwd |
| Yahoo | tonyyahoo | tonyyahoopwd |
| Google Talk | tonygt | tonygtpwd |
| SIP | tonysip | tonysippwd |

In practice, a Skype or any IM/SIP account can also be a main log-in account, and the system with additional account is not a must. This is the manage principle of the system. While a user end logs in the system, one or more network communication programs, such as Skype, MSN, etc., owned by the user end can be logged in simultaneously. The choice can be one, more or nothing, and corresponding accounts and passwords are provided at that time.
Callee path or calling policy: The account of Tony is on the personal contact list, which has an extension number and other contact information listed below:

| Employee | | Tony |
|---|---|---|
| Selective | Personal account | employee1 |
| path | Extension number | 120 |
| | Taiwan Mobile Phone 1 | 0933-999999 |
| | Taiwan Mobile Phone 2 | 0968-567123 |
| | Taiwan Local Telephone | 02-77768888 |
| | China Mobile Phone | +86139-22223333 |

Call-in: notification/ringing for a single contact path can be set while a call from outside to employee1. For instance, an extension number 120 is designated as a call-in number while Tony is in his office; a call is forwarded to his China mobile phone, +86139-22223333, while Tony is on a business trip to Shanghai, the way for transferring is a general network phone operation, which is not described further; or such network communication programs can be set to be notified in order or simultaneously. The purpose is to connect to the communication devices of Tony.
Call-out: After log-in, the representative log-in unit 454 may log in to any, part or all of the accounts of Skype, MSN, Yahoo, Google Talk, SIP, etc. at the moment. The user end receives the information of the all contact objects corresponding to the accounts of the database 480 through the computer 305 or other devices with browsers. The phone book assembled by all contact objects is divided into two types, public phone book and private phone book. A call for calling out can be made while the user end clicks on the phone book.

| | |
|---|---|
| Public Phone Book | |
| [symbol] Corp1 | C1p1 |
| | C1p2 |
| | . . . |
| [symbol] Corp2 | C2p1 |
| | C2p2 |
| | . . . |
| [symbol] Corp3 ... | |
| Private Phone Book | |
| [symbol] Skype group | skype:sid1 |
| | skype:sid2 |
| | - - - |
| [symbol] MSN group | msn:mid1 |
| | msn:mid2 |
| | . . . |
| [symbol] Yahoo group | yahoo:yid1 |
| | yahoo:yid2 |
| | . . . |
| [symbol] SIP group | sip:sipid1 |
| | sip:sipid2 |
| | . . . |
| Google Talk group | gt:gtid1 |
| | gt:gtid2 |
| | . . . |

Clicking on a Web page or a specific agent interface is to activate a call. Through a preset calling policy, a communication device for Tony that is the most convenient for Tony at the moment can be designated first, then a call to the contact object can be made.

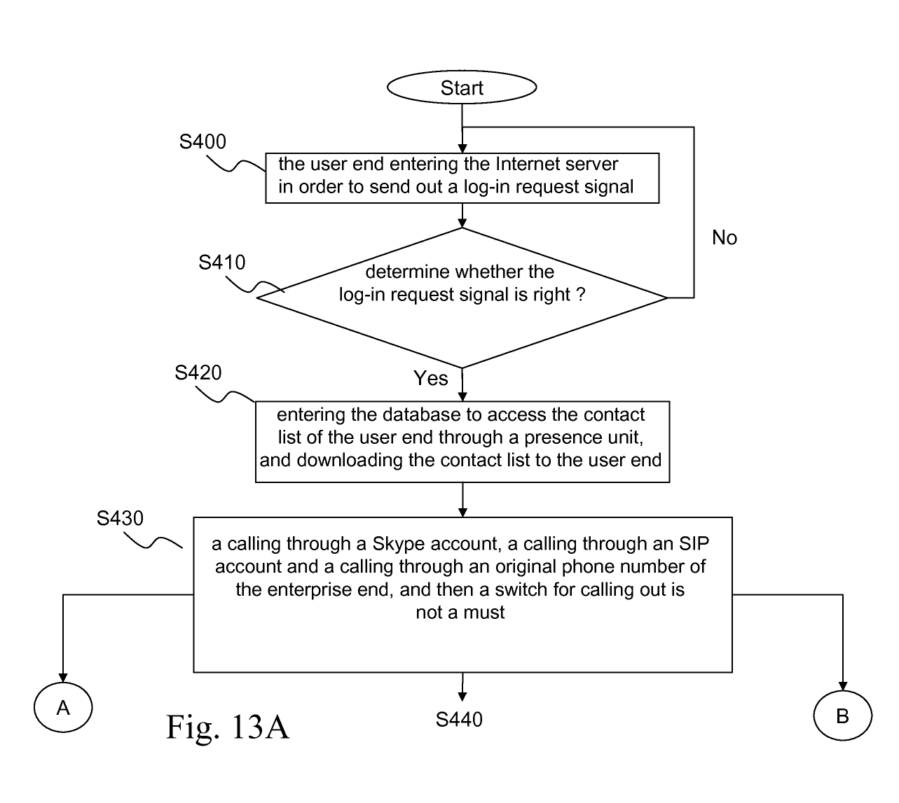

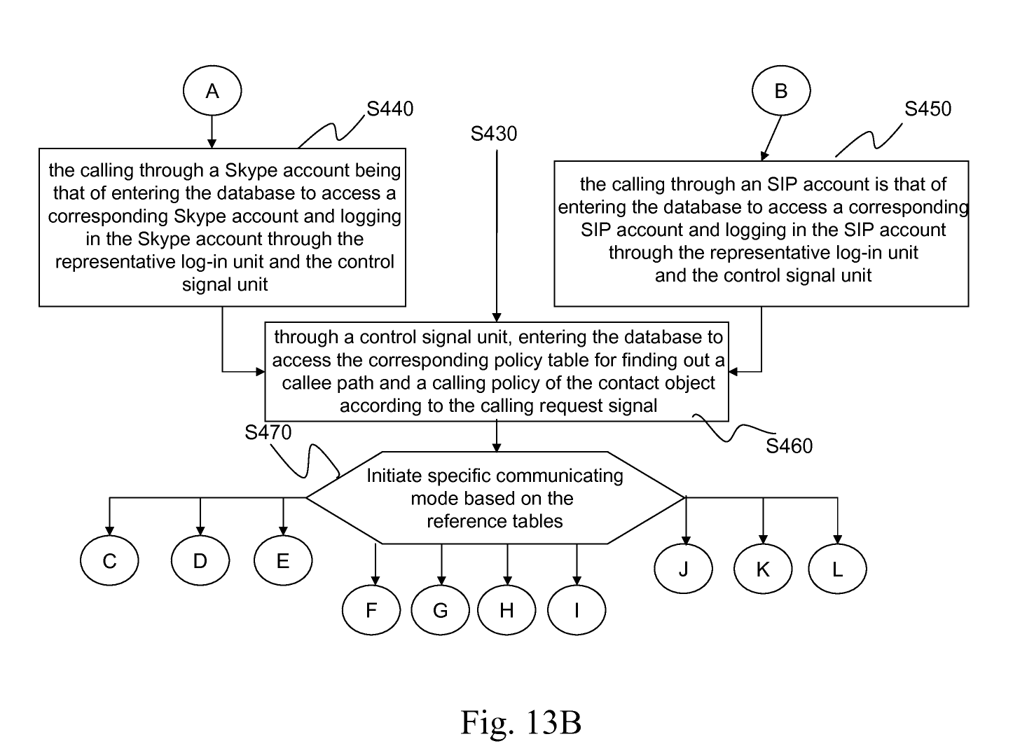

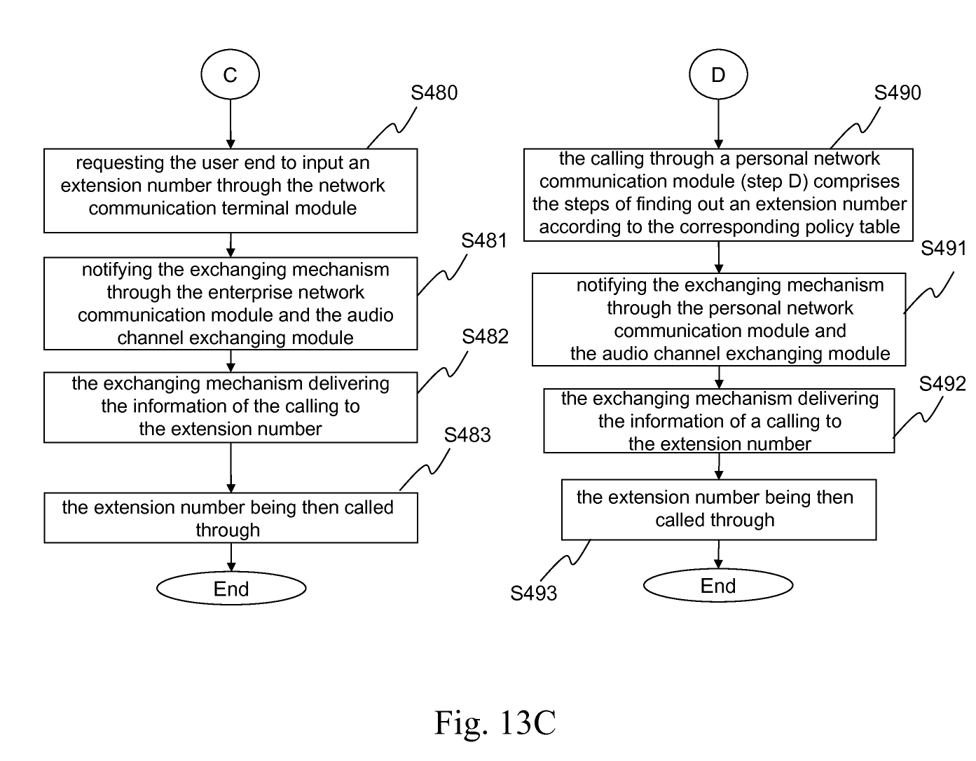

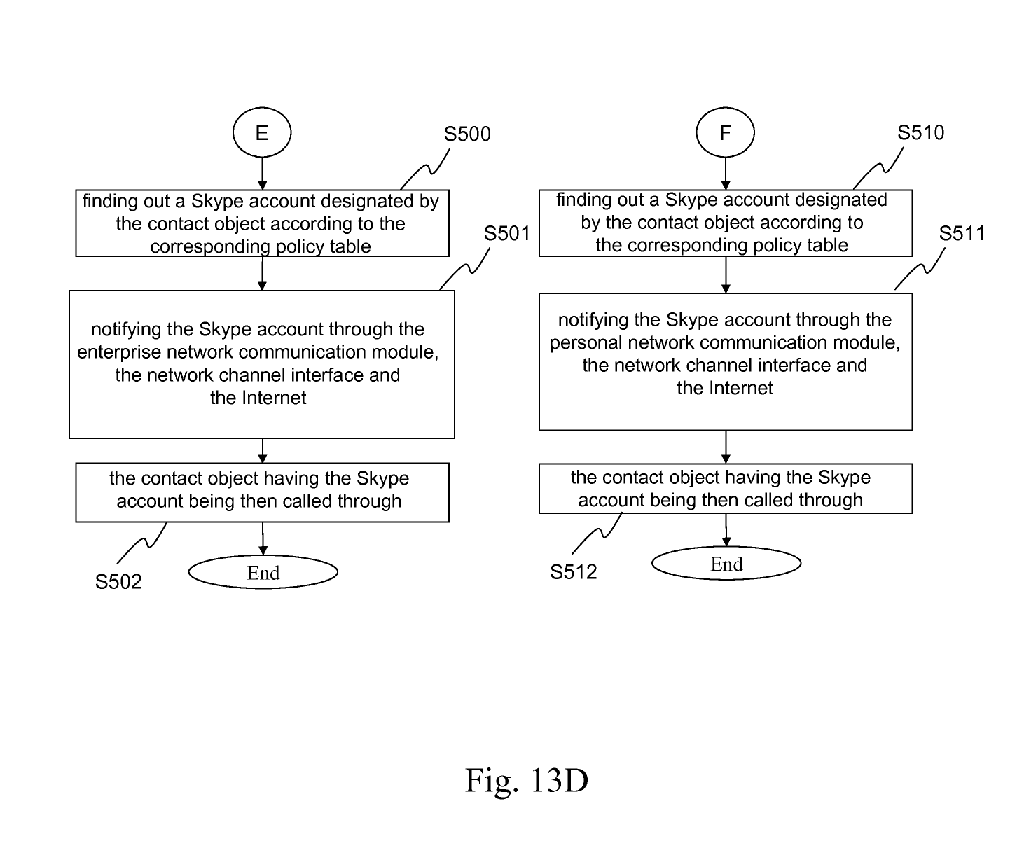

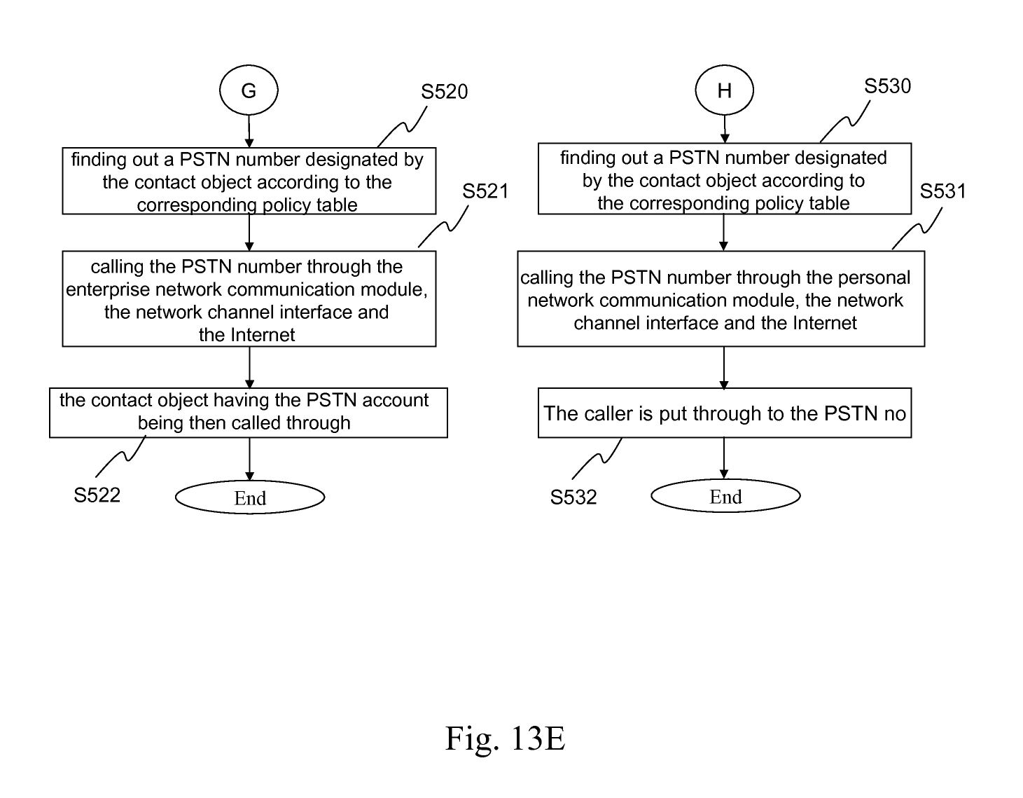

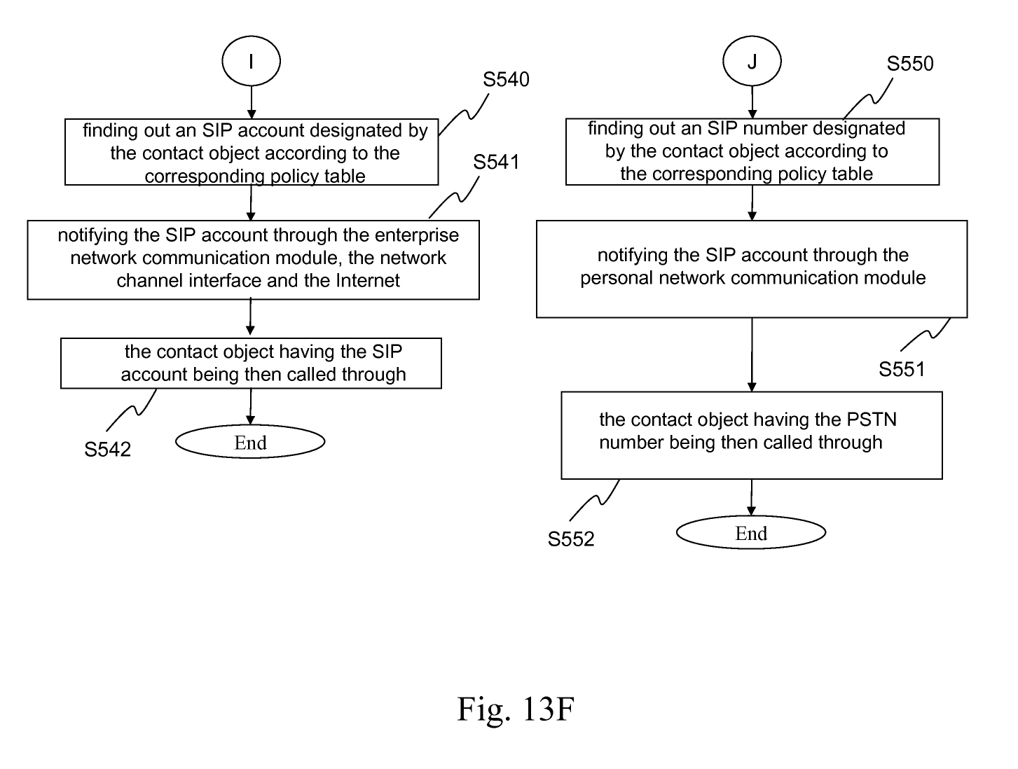

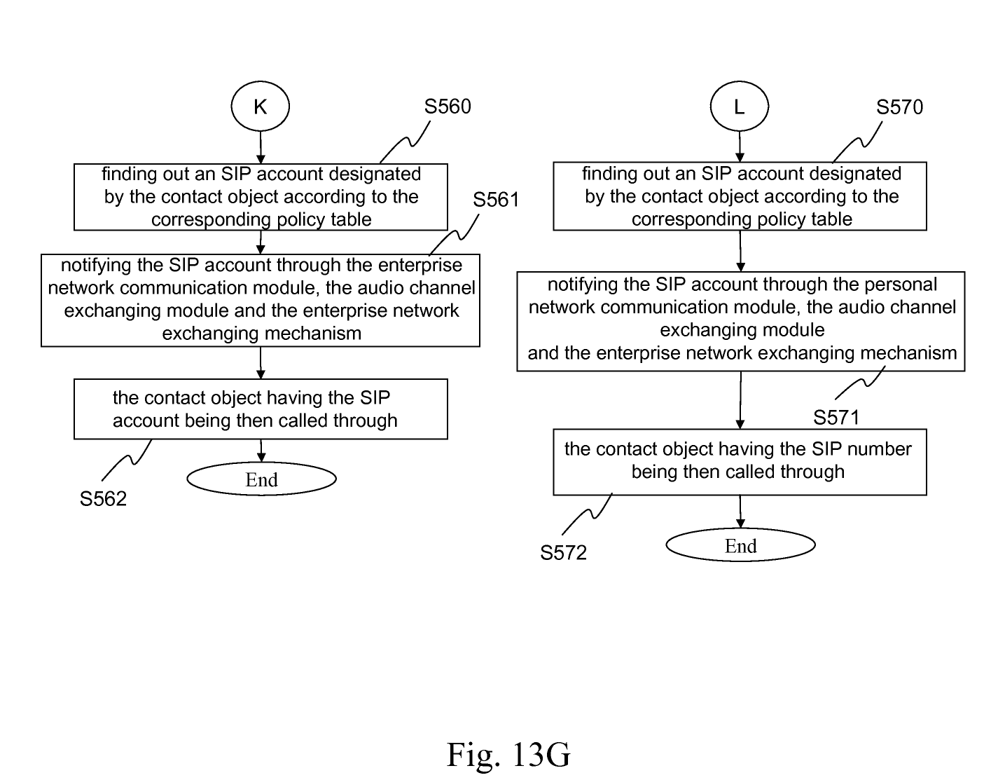

For details, with reference to FIG. 13A to FIG. 13G, which illustrate a call-in flow chart of the third preferred embodiment of the network communication method for supporting the non-specific network protocols of the present invention. The method includes the steps of:

the user end entering the Internet server 490 in order to send out a log-in request signal (S400);
entering the database 480 to access data through the Internet server 490 in order to determine whether the log-in request signal is right (S410); if yes, going back to (S400), if no,
entering the database 480 to access the contact list of the user end through a presence unit 452, and downloading the contact list to the user end (S420);
the user end selecting at least one contact object (as callee) of the contact list and sending out a calling request signal through the Internet network and the network channel interface 410, and sending out a calling out rule to the network communication terminal module, wherein the calling out rule is selected from the group consisting of: a calling through a Skype account, a calling through an SIP account and a calling through an original phone number of the enterprise end, and then a switch for calling out is not a must (S430); the calling through a Skype account being that of entering the database 480 to access a corresponding Skype account and logging in the Skype account through the representative log-in unit 454 and the control signal unit 451 (S440); the calling through an SIP account is that of entering the database 480 to access a corresponding SIP account and logging in the SIP account through the representative log-in unit 454 and the control signal unit 451 (S450), wherein the SIP account is selected from the group consisting of: an MSN account, a Yahoo messenger account, a Google Talk account, etc., thus the corresponding policy table at least comprising the columns of: Skype account and password, extension number, PSTN number, SIP account, preset path, and calling policy, wherein any column can be with a plurality of data. Since the concept of UC is to integrate the all communication ways of the user end, hence all the communication paths can be involved.
After finishing (S430), (S440) and (S450), through a control signal unit 451, entering the database 480 to access the corresponding policy table for finding out a callee path and a calling policy of the contact object according to the calling request signal (S470), wherein the callee path at least comprises: an extension mode, a Skype account mode, an SIP mode, and a PSTN mode;
wherein the extension mode having two ways for calling, which are of a calling through an enterprise network communication module (step C) and a calling through a personal network communication module (step D); wherein the calling through an enterprise network communication module (step C) comprises the steps of: requesting the user end to input an extension number through the network communication terminal module 420 (S480); notifying the exchanging mechanism 470 through the enterprise network communication module 430 and the audio channel exchanging module 460 (S481); the exchanging mechanism 470 delivering the information of the calling to the extension number (S482); and the extension number being then called through (S483), and the calling through a personal network communication module (step D) comprises the steps of finding out an extension number according to the corresponding policy table (S490); notifying the exchanging mechanism 470 through the personal network communication module 440 and the audio channel exchanging module 460 (S491); the exchanging mechanism 470 delivering the information of a calling to the extension number (S492); and the extension number being then called through (S493);
wherein the Skype account mode has two ways for calling, which are of a calling through an enterprise network communication module (step E) and a calling through a personal network communication module (step F); wherein the calling through an enterprise network communication module (step E) comprises the steps of: finding out a Skype account designated by the contact object according to the corresponding policy table (S500); notifying the Skype account through the enterprise network communication module 430, the network channel interface 410 and the Internet (S501); and the contact object having the Skype account being then called through (S502), and the calling through a personal network communication module (step F) comprises the steps of: finding out a Skype account designated by the contact object according to the corresponding policy table (S510); notifying the Skype account through the personal network communication module 440, the network channel interface 410 and the Internet (S511); and the contact object having the Skype account being then called through (S512);
wherein the PSTN account mode has two ways for calling, which are of a calling through an enterprise network communication module (step G) and a calling through a personal network communication module (step H); wherein the calling through an enterprise network communication module (step G) comprises the steps of: finding out a PSTN number designated by the contact object according to the corresponding policy table (S520); calling the PSTN number through the enterprise network communication module 430, the network channel interface 410 and the Internet (S521); and the contact object having the PSTN account being then called through (S522), and the calling through a personal network communication module (step H) comprises the steps of: finding out a PSTN number designated by the contact object according to the corresponding policy table (S530); calling the PSTN number through the personal network communication module 440, the network channel interface 410 and the Internet (S531); and the contact object having the PSTN number being then called through;
wherein the SIP account mode has four ways for calling, which are of (step I), (step J), (step K), and (step L); wherein (step I) comprises the steps of: finding out an SIP account designated by the contact object according to the corresponding policy table (S540); notifying the SIP account through the enterprise network communication module 430, the network channel interface 410 and the Internet (S541); and the contact object having the SIP account being then called through (S542); (step J) comprises the steps of: finding out an SIP number designated by the contact object according to the corresponding policy table (S550); notifying the SIP account through the personal network communication module 440, the network channel interface 410 and the Internet (S551); and the contact object having the PSTN number being then called through (S552); (step K) comprises the steps of: finding out an SIP account designated by the contact object according to the corresponding policy table (S560); notifying the SIP account through the enterprise network communication module 430, the audio channel exchanging module 460 and the enterprise network exchanging mechanism 402; and the contact object having the SIP account being then called through; and (step L) comprises the steps of: finding out an SIP account designated by the contact object according to the corresponding policy table (S570); notifying the SIP account through the personal network communication module 440, the audio channel exchanging module 460 and the enterprise network exchanging mechanism 402; and the contact object having the SIP number being then called through.

For instance, Tony wants to call a contact object sid1 on the Skype. The contact object sid1 is found out from the phone book of a Skype group and clicked. After the Internet server 490 receives the instruction, a message for calling sid1 on the Skype is delivered to the control signal unit 451. While Tony is in his office and a call forwarded back to an extension number 120 is set up, the control signal unit 451 may call the exchanging mechanism 470 through the audio channel exchanging module 460. After the exchanging mechanism 470 answers the call, a DTMF signal is thus delivered out. The phone 7 of the extension number 120 is off-hook. The control signal unit 451 may send out an instruction to the personal network communication module 440 while receiving the event of the audio channel exchanging module 460 detecting that the phone 7 is off-hook. The personal account tonyskype of the Skype account of Tony is designated to call sid1. If sid1 is on-line and supports the function of caller ID, the characters, tonyskype, of the caller can then be seen.

Similarly, For instance, Tony wants to call a contact object sid1 on the MSN. The contact object mid1 is found out from the phone book of an MSN group and clicked. After the Internet server 490 receives the instruction, similar operations are then proceeded. The personal account tonymsn of the MSN account of Tony is designated to call mid1. If mid1 is on-line and supports the function of caller ID, the characters, tonymsn, of the caller can then be seen. Others as Yahoo, Google Talk and SIP are almost the same.

Through the method of the present invention, no matter any network communication program as Skype, MSN, Yahoo messenger, Google Talk, etc., the system can easily switch the communications among aforesaid network communication programs. Further, the communications for voice, multimedia, telephone, character, file, etc. are involved as well. That is, unified communications (UC) are totally applied in gateways to figure out the problem that the present integrated communications cannot be compatible with Skype. Hence, adding a device can approach the solution to the problem, and avoids the situation of spending a large amount of cost to construct the environment to UC.

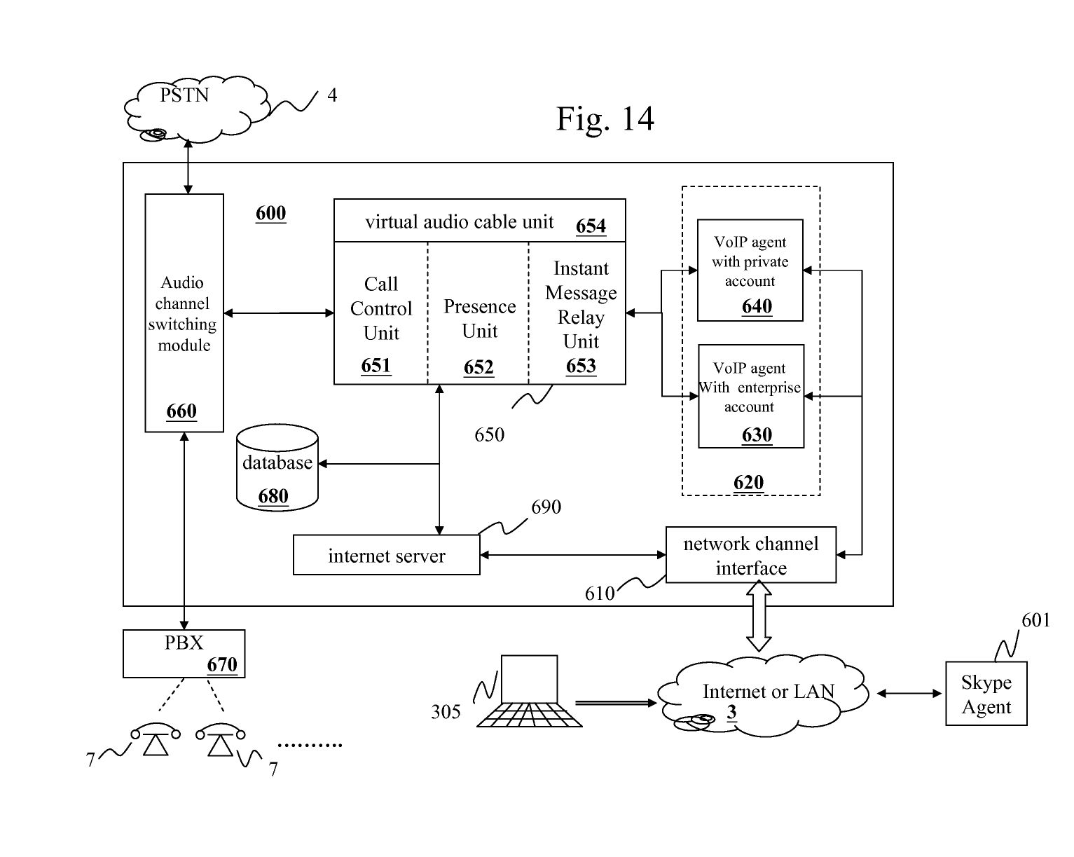

With reference to FIG. 14, which illustrates a schematic view of a structure of a fourth preferred embodiment of the network communication system for supporting non-specific network protocols of the present invention of the present invention. The system is applied to a Skype way in gateways in order to make enterprise ends easily manage the communications of the Skype, and the numbers of individual user ends and the representative numbers of the enterprise ends can be shown, adopting a special way of callback makes communications clearer. As shown in the figure, the network communication system 600 for supporting non-specific network protocols includes a network channel interface 610, a network communication terminal module 620, a core intermediate module 650, an audio channel exchanging module 660, an Internet server 680, and a database 690; further that, extension numbers of the enterprise ends and the external contact objects can be communicated with through the exchanging mechanism 670 and a Skype agent 601. The details are as that of:

the network channel interface 610, delivering and acquiring the signals of network packets, wherein the network channel interface at least comprises: a transmission control protocol (TCP) and a user datagram protocol (UDP);
the network communication terminal module 620, processing network voice communications and at least comprising: a personal network communication module 640, processing the ID information of the employees of the enterprise ends; and an enterprise network communication module 630, processing the ID information of the enterprise ends; wherein the numbers of individual user ends and the representative numbers of the enterprise ends can be shown through the enterprise network communication module 630 and the personal network communication module 640, processing the ID information of the employees of the enterprise ends;
a core intermediate module 650, controlling and processing the signals of the network communication system, processing the codes and decodes of the streams of audio signals, and proceeding the process of feed-in and feed-out, comprising: a control signal unit 651, selecting audio channels, giving channel signal commands and parameters; a presence unit 652, acquiring, processing and delivering presence data acquired by the network communication terminal module, wherein the presence data are translated and delivered out;
an instant message relay unit 653, acquiring instant messages from the network communication terminal module, wherein the instant messages are translated and delivered out; and an audio channel exchanging module 660, building up, processing and maintaining the audio signals, and further detecting, filtering and generating telecommunication signals supported by hardware interfaces, the control signal unit ordering the audio channel exchanging module, wherein the audio channel exchanging module 660 at least comprises: a session initiation protocol (SIP), an E1/T1 interface, a foreign eXchange station (FXS), and a foreign eXchange office (FXO);
an Internet server 680, delivering and acquiring a message and a control signal, acquiring all log-in demands, and communicating with the network communication terminal module, delivering instant messages to the instant message relay unit, the instant messages being translated and delivered out by the instant message relay unit after the instant message relay unit acquires the instant messages; and
a database 690, storing the confirmations of the log-ins of user ends, authorization information, policy tables, and the authorization and confirmation information in the network communication terminal module.

FIG. 12 is a specific embodiment, which adopts a simple system structure of the Skype.

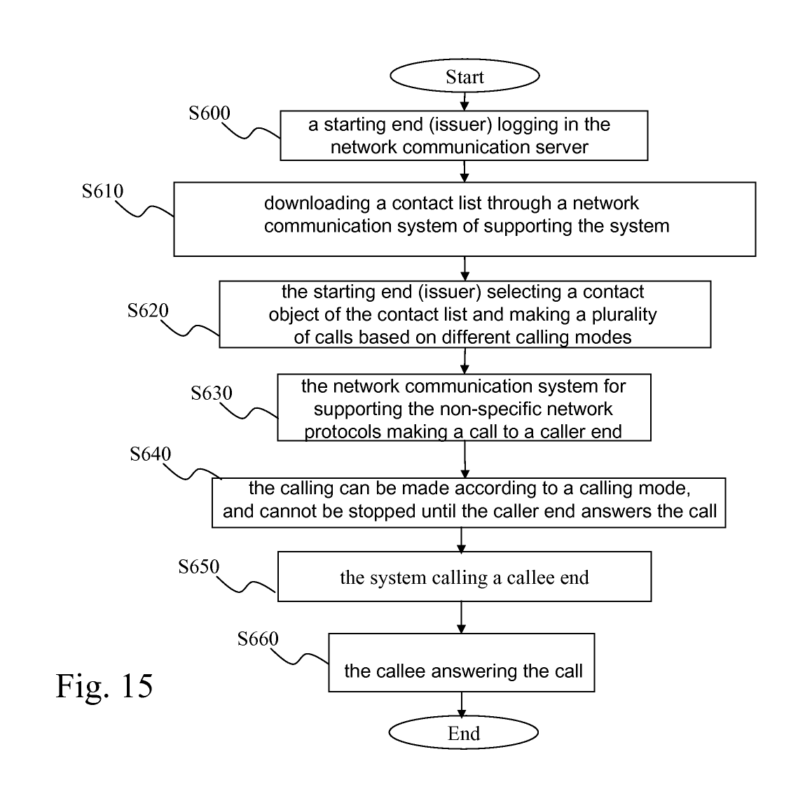

The present invention uses a special callback way to let the communication way and the charging way be clearer so as to avoid invalid calls for saving cost. The most important is to solve the problem that Skype cannot be managed by enterprise ends as always, and another problem that Skype can only present personal codes but not the representative numbers of the enterprise codes. Through the database 680, the related information and data of Skype of the user ends of an enterprise end are stored. Introducing the original features of Skype as good communication quality, cost-saving programs, etc. to enterprise ends may let the telephone charge of those enterprise ends be saved; further that, the calling time and cost of each user end of an enterprise end may be monitored and managed more easily. For details, with reference to FIG. 15, which illustrates a call-in flow chart of the fourth preferred embodiment of the network communication method for supporting non-specific network protocols of the present invention. The method describes the special way of the callback and includes the steps of:

a starting end (issuer) logging in the network communication server 690 (S600);
downloading a contact list through a network communication system of supporting the system (S610);
the starting end (issuer) selecting a contact object of the contact list and making a plurality of calls based on different calling modes (S620), wherein the calling modes at least comprise: a mode of simultaneously calling all callee end paths, a mode of calling all callee end paths in order, and a mode of calling preset callee end paths, wherein the mode of simultaneously calling all callee end paths is that of other callee end paths being interrupted while one callee end path is answered, so that the situations of the repeated call and the occupied line can be avoided; the network communication system 600 for supporting the non-specific network protocols making a call to a caller end (S630); the calling can be made according to a calling mode, and cannot be stopped until the caller end answers the call (S640), this being defined as a callback step; the system 600 calling a callee end (S650); and the callee answering the call (S660).
In (S650), calling the callee end may have three calling modes comprise: a mode of simultaneously calling all callee end paths, a mode of calling all callee end paths in order, and a mode of calling preset callee end paths. So that the callee end can be sure to communicate with the caller end.

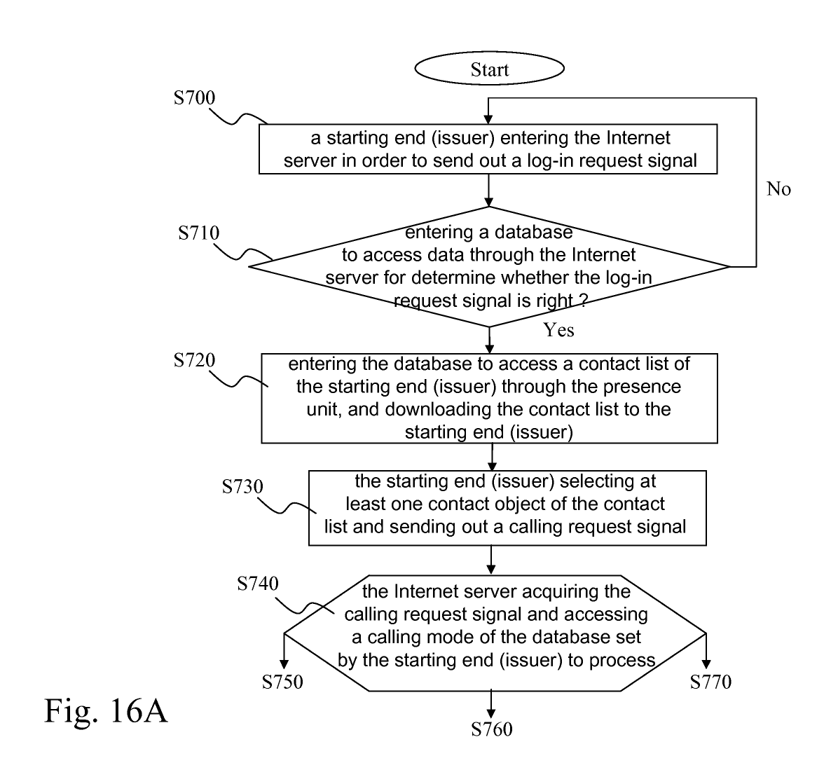

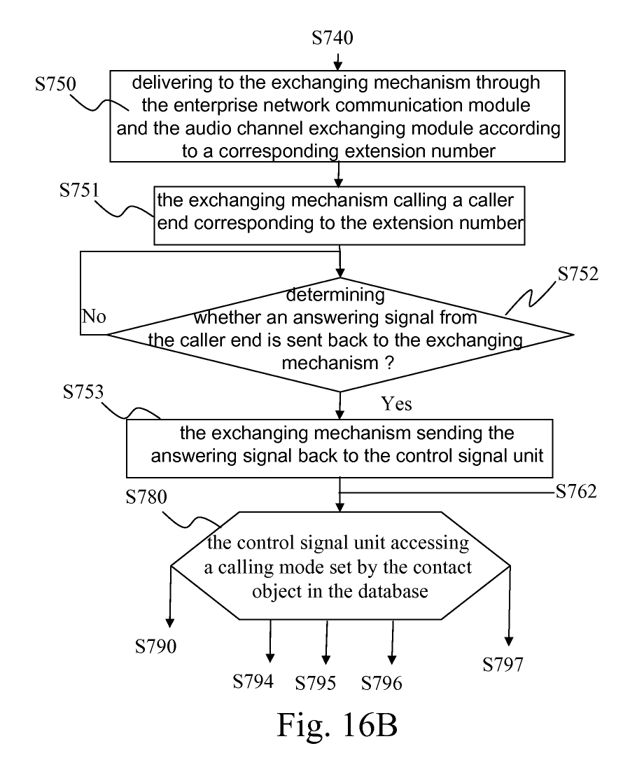

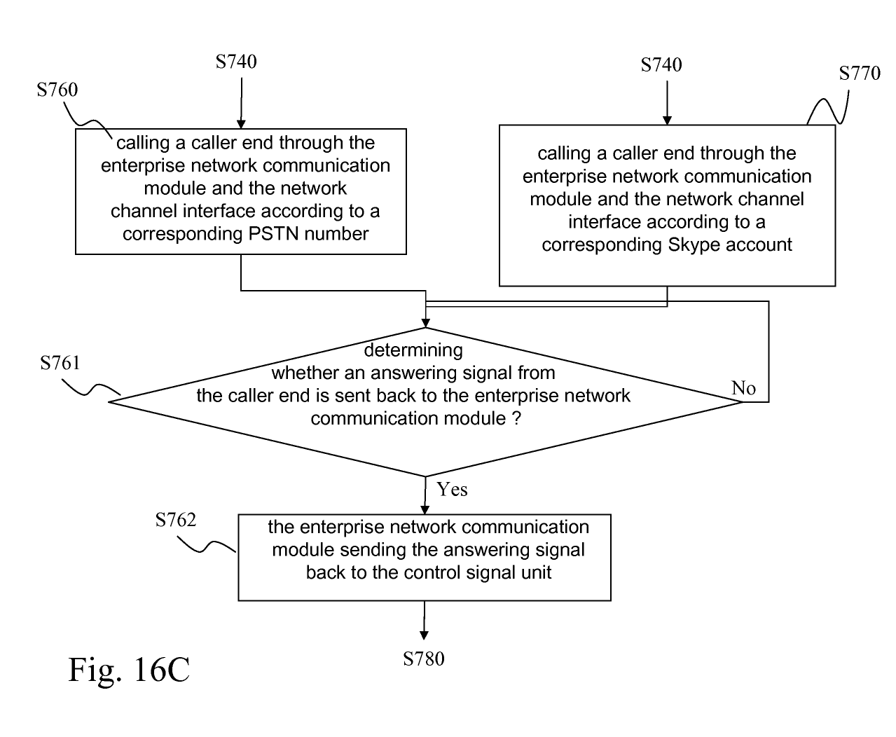

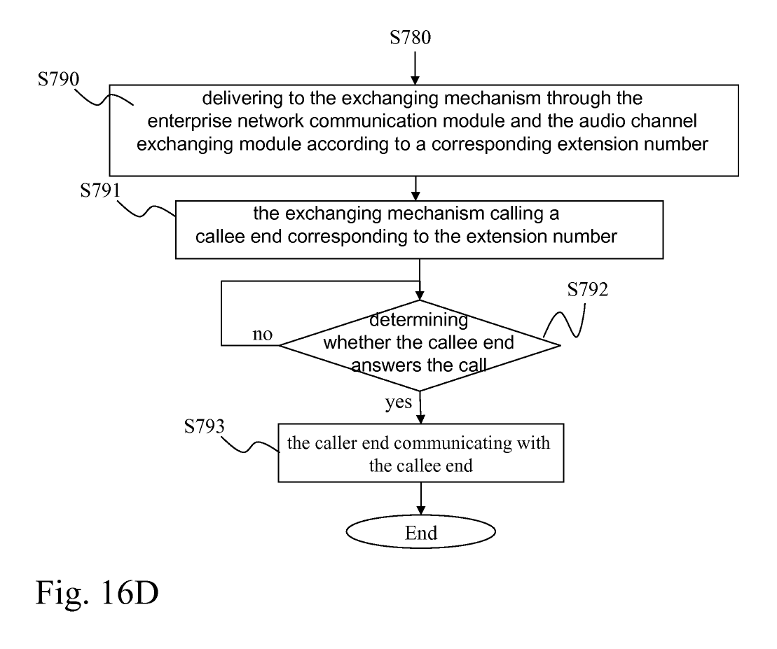

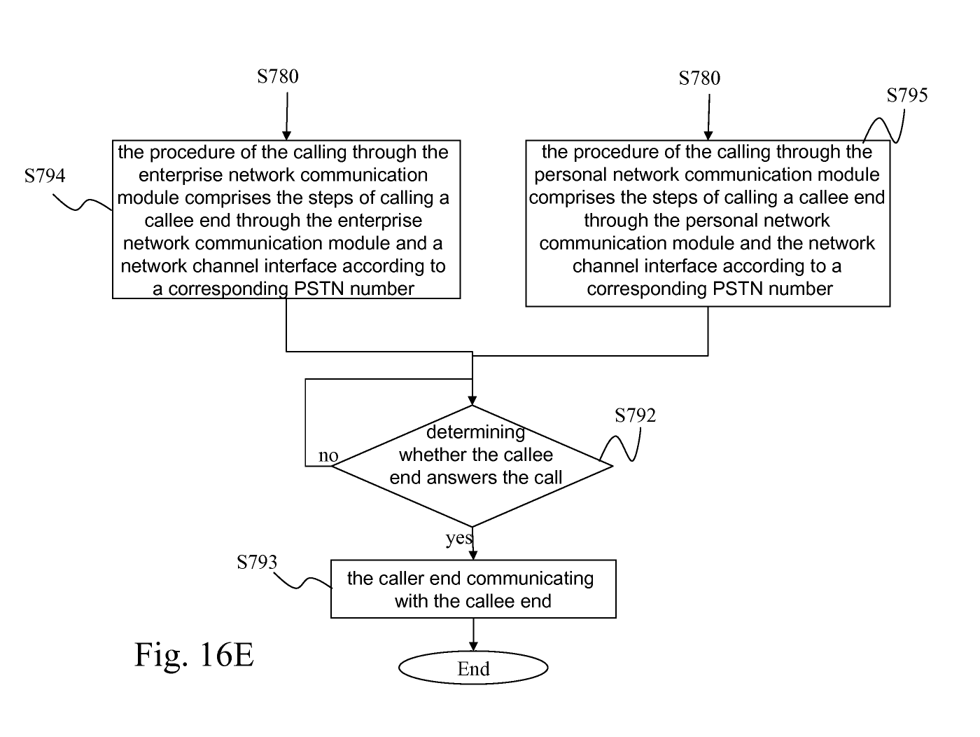

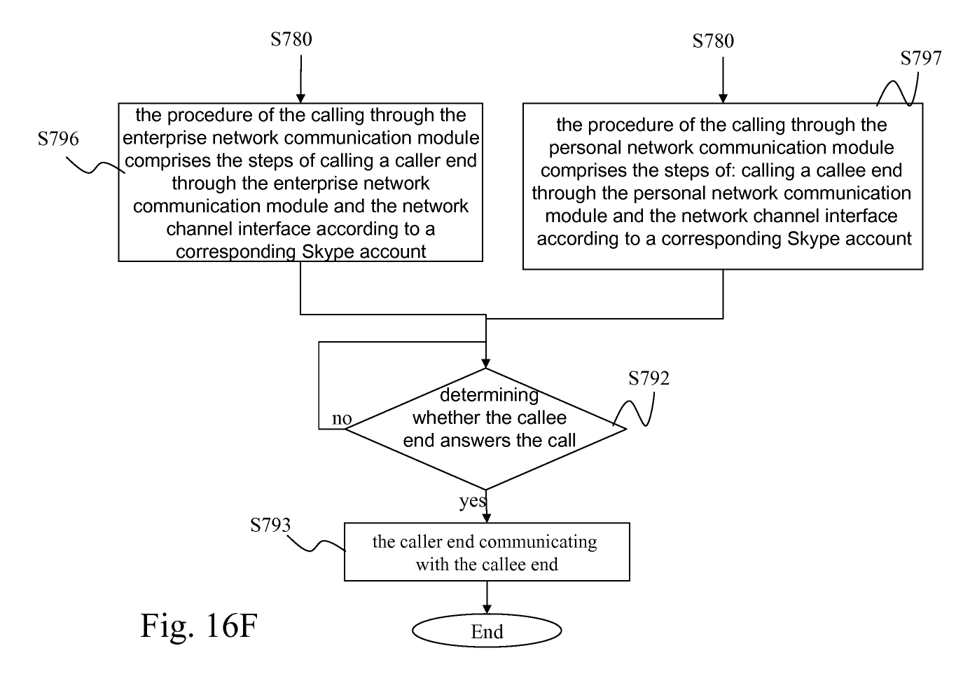

With references to FIG. 16A to FIG. 16F, which illustrate a call-in flow chart of the third preferred embodiment of the network communication method for supporting the non-specific network protocols of the present invention. The method includes the steps of:

a starting end (issuer) entering the Internet server 690 in order to send out a log-in request signal (S700);
entering a database to access data through the Internet server 690 in order to determine whether the log-in request signal is right (S710); if no, going back to (S700), if yes,
entering the database 680 to access a contact list of the starting end (issuer) through the presence unit 652, and downloading the contact list to the starting end (issuer) (S720);
the starting end (issuer) selecting at least one contact object (as callee) of the contact list and sending out a calling request signal (S730);
the Internet server 690 acquiring the calling request signal and accessing a calling mode of the database 680 set by the starting end (issuer) to process (S740), wherein the calling mode at least comprise: a mode of simultaneously calling all callee end paths, a mode of calling all callee end paths in order, and a mode of calling preset callee end paths, wherein the mode of simultaneously calling all callee end paths is that of other callee end paths being interrupted while one callee end path is answered;
wherein the callee end path comprises three modes, which are an extension mode, an outside (Skype out) mode and a Skype (Skype in) mode,
wherein the extension mode for calling comprises the steps of:
delivering to the exchanging mechanism 670 through the enterprise network communication module 630 and the audio channel exchanging module according to a corresponding extension number (S750);
the exchanging mechanism 670 calling a caller end corresponding to the extension number (S751);
determining whether an answering signal from the caller end is sent back to the exchanging mechanism (670) (S752); if no, going back to (S752), if yes,
the exchanging mechanism 670 sending the answering signal back to the control signal unit 651 (S753);
wherein the outside (Skype out) mode for calling comprises the steps of:
calling a caller end through the enterprise network communication module and the network channel interface according to a corresponding PSTN number (S760);
determining whether an answering signal from the caller end is sent back to the enterprise network communication module (S761); if no, going back to (S761), if yes,
the enterprise network communication module sending the answering signal back to the control signal unit (S672);
wherein the Skype (Skype in) mode for calling comprises the steps of:
calling a caller end through the enterprise network communication module and the network channel interface according to a corresponding Skype account (S770);
determining whether an answering signal from the caller end is sent back to the enterprise network communication module (S761); if no, going back to (S761), if yes,
the enterprise network communication module sending the answering signal back to the control signal unit (S762);
after (S753) and (S762), the control signal unit 651 accessing a calling mode set by the contact object in the database 680 (S780), wherein the calling modes at least comprise: a mode of simultaneously calling all callee end paths, a mode of calling all callee end paths in order, and a mode of calling preset callee end paths, wherein the mode of simultaneously calling all callee end paths is that of other callee end paths being interrupted while one callee end path is answered;
wherein the callee end path comprises three modes, which are an extension mode, an outside (Skype out) mode and a Skype (Skype in) mode,
wherein the extension mode for calling comprises the steps of:
delivering to the exchanging mechanism 670 through the enterprise network communication module 630 and the audio channel exchanging module 660 according to a corresponding extension number (S790);
the exchanging mechanism 670 calling a callee end corresponding to the extension number (S791);
determining whether the callee end answers the call (S792); if no, going back to (S792), if yes, the caller end communicating with the callee end.
Wherein the outside (Skype out) mode for calling comprises two procedures, which are of: a calling through an enterprise network communication module and a calling through a personal network communication module;
wherein the procedure of the calling through the enterprise network communication module comprises the steps of calling a callee end through the enterprise network communication module 630 and a network channel interface 610 according to a corresponding PSTN number (S794); determining whether the callee end answers the call (S792), if no, going back to (S792), if yes, the caller end communicating with the callee end.
Wherein the procedure of the calling through the personal network communication module comprises the steps of calling a callee end through the personal network communication module 640 and the network channel interface 610 according to a corresponding PSTN number (S795); determining whether the callee end answers the call (S792), if no, going back to (S792), if yes, the caller end communicating with the callee end (S793).
Wherein the Skype (Skype in) mode for calling comprises two procedures, which are of: a calling through an enterprise network communication module and a calling through a personal network communication module;
wherein the procedure of the calling through the enterprise network communication module comprises the steps of calling a caller end through the enterprise network communication module 630 and the network channel interface 610 according to a corresponding Skype account (S796); determining whether the callee end answers the call (S792), if no, going back to (S792), if yes, the caller end communicating with the callee end (S793).
wherein the procedure of the calling through the personal network communication module comprises the steps of: calling a callee end through the personal network communication module 640 and the network channel interface 610 according to a corresponding Skype account (S797); determining whether the callee end answers the call (S792), if no, going back to (S792), if yes, the caller end communicating with the callee end (S793).

Through above method, the special callback way of calling back to a caller end may let the communication way and the charging way be clearer, since other calling actions are interrupted until a phone is off-hook, the caller end and the callee end are definitely communicated with each other. Another advantage of the method, the caller end is not necessary to remember the all calling ways for the all callee ends due to that the all calling ways are in the system. All the caller end needs is a device able to browse the Web pages. In case of the caller end being without a phone, hence any phone, a public phone, another personal mobile phone, etc., around him can be connected to a callee end because of the callback way, which makes the phone around the caller end be a starting end, and the phone can be connected through end while a contact object is selected by the caller end. However, the method has two calling procedures that are from a representative enterprise number and a personal number, and thus the representative enterprise number can be selected to call the caller end that is the phone around him. While the call is connected through to the callee end, the telephone charge is paid by the enterprise end. Hence, the phone around the caller end would not need to pay the telephone charge. The system can manage all the detail telephone bills so as to improve the conveniences of the user ends of an enterprise end and monitor all the communications of the user ends.

For above all calling procedures, only calling a PSTN number may cause a problem of paying the phone charge. This is a characteristic of Skype and will not be described any further hereinafter.

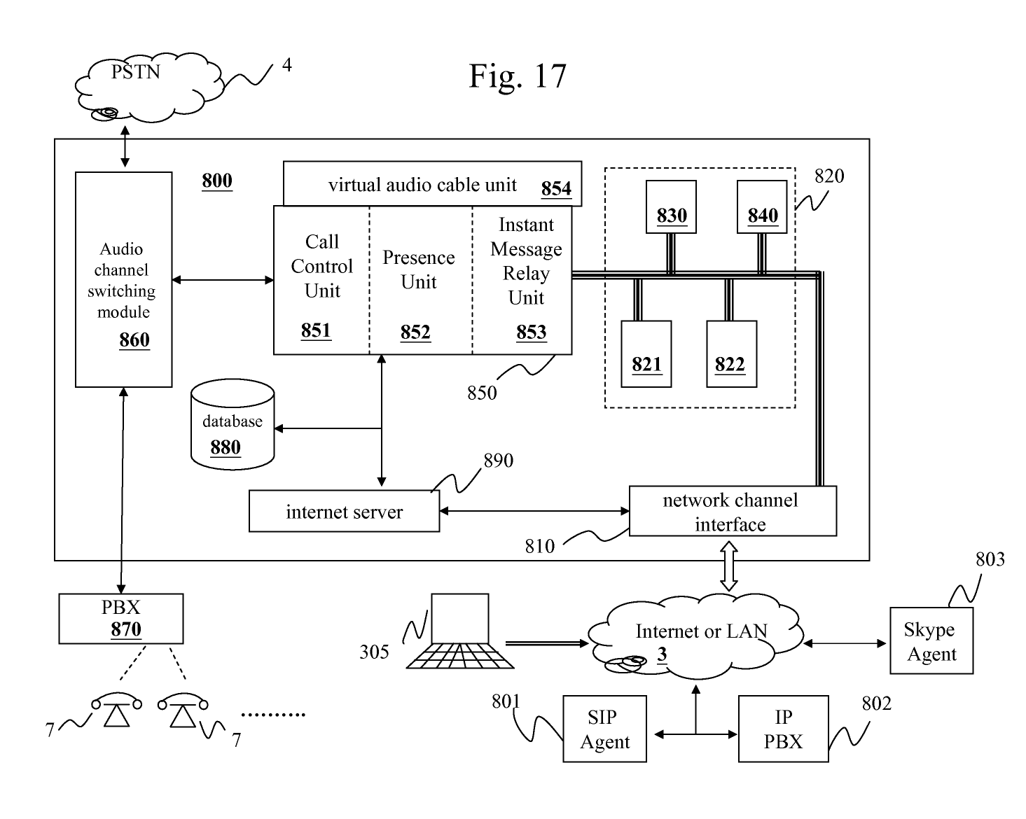

With reference to FIG. 17, which illustrates a schematic view of a structure of a fifth preferred embodiment of the network communication system for supporting the non-specific network protocols of the present invention of the present invention. The system is applied to a Skype way in gateways in order to make enterprise ends easily manage the communications of the Skype and approach features of light-weight and high-flexibility, and the numbers of individual user ends and the representative numbers of the enterprise ends being shown, and the system 800 comprises: a network channel interface 810, a network communication terminal module 820, a core intermediate module 850, an audio channel exchanging module 860, an Internet server 880, and a database 890; further, through an exchanging mechanism 870, the extension numbers of an enterprise can be through. Through an enterprise network exchanging mechanism 802, an SIP account can be through either. By means of an SIP agent 801, an SIP account can be communicated with, or through a Skype agent 803, a Skype account can be communicated with as well. For more detail, the descriptions are as that of:

the network channel interface 810, delivering and acquiring the signals of network packets, wherein the network channel interface at least comprises: a transmission control protocol (TCP) and a user datagram protocol (UDP);
the network communication terminal module 820, processing network voice communications and at least comprising: a personal network communication module 840, processing the ID information of the employees of the enterprise ends; and an enterprise network communication module 830, processing the ID information of the enterprise ends;
wherein the numbers of individual user ends and the representative numbers of the enterprise ends can be shown through the enterprise network communication module 830 and the personal network communication module 840, besides, two terminal modules being provided for multiple service levels and dynamic configurations, wherein the two terminal modules are a first terminal module (Micro) for general processing and a second terminal module (Normal) for complete functions and implementing the process of complete user experience;
a core intermediate module 850, controlling and processing the signals of the network communication system, processing the codes and decodes of the streams of audio signals, and proceeding the process of feed-in and feed-out, comprising: a control signal unit 851, selecting audio channels, giving channel signal commands and parameters;
a presence unit 852, acquiring, processing and delivering presence data acquired by the network communication terminal module, wherein the presence data are translated and delivered out;
an instant message relay unit 853, acquiring instant messages from the network communication terminal module and the Internet server, wherein the instant messages are translated and delivered out;
an audio channel exchanging module 860, building up, processing and maintaining the audio signals, and further detecting, filtering and generating telecommunication signals supported by hardware interfaces, the control signal unit ordering the audio channel exchanging module, wherein the audio channel exchanging module 860 at least comprises: a session initiation protocol (SIP), an E1/T1 interface, a foreign eXchange station (FXS), and a foreign eXchange office (FXO);
an Internet server 880, delivering and acquiring a message and a control signal, acquiring all log-in demands, and communicating with the network communication terminal module, delivering instant messages to the instant message relay unit, the instant messages being translated and delivered out by the instant message relay unit after the instant message relay unit acquires the instant messages; and
a database 490, storing the confirmations of the log-ins of user ends, authorization information, policy tables, and the authorization and confirmation information in the network communication terminal module.

According to the fourth preferred embodiment, which discloses the advantages of the system, so it may not be further described. With the difference between the fifth preferred embodiment and the fourth preferred embodiment, the fifth preferred embodiment provides two terminal modules. The first terminal module possesses simpler functions, which are a usage rate of 80% in an enterprise end; the second terminal module is able to completely process some works and possesses complicate functions. Due to thousands of employees in a large enterprise using the system, in case of each employee using the complicate functions, a large amount of CPUs and RAMs shall be equipped to the system for the requests. For the aspect of building the system, it is not flexible enough. But, the real situations are there, hence the two terminal module are a must and process different kinds of work. Similarly, if one or more requests are happening, the system is extendable so as to reach the features of light-weight and flexibility.

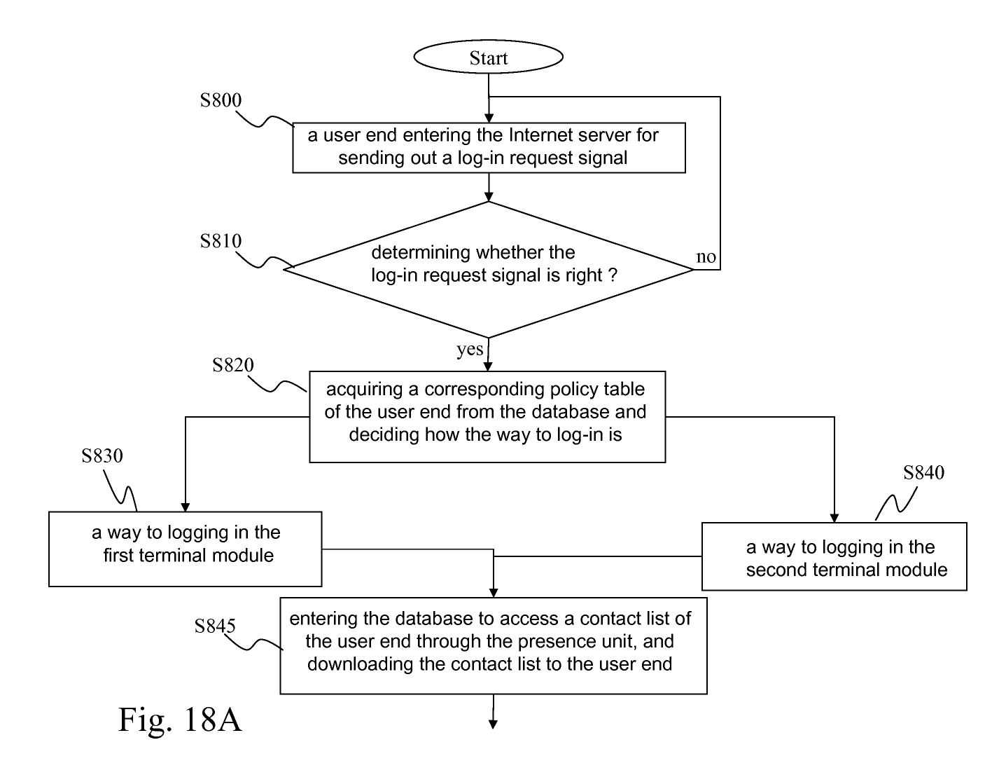

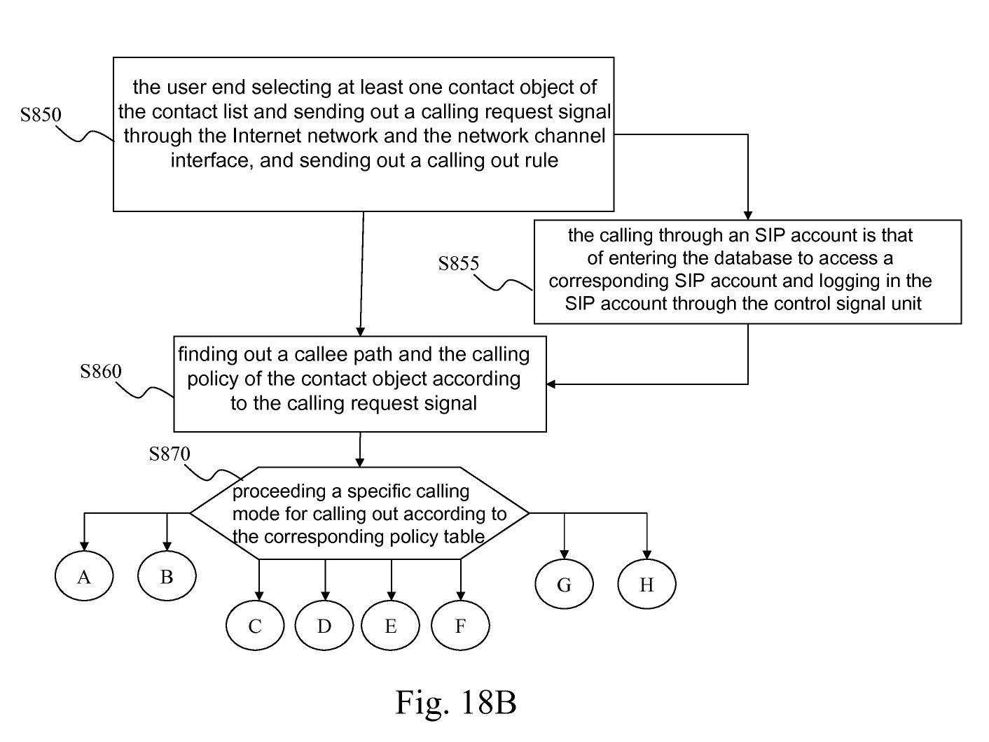

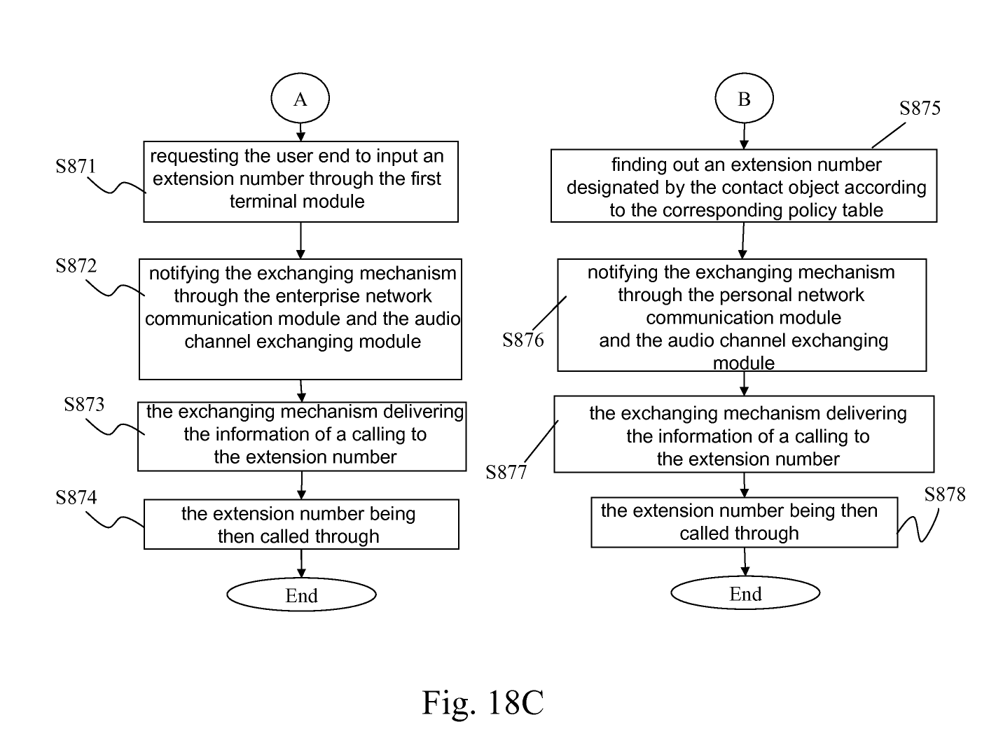

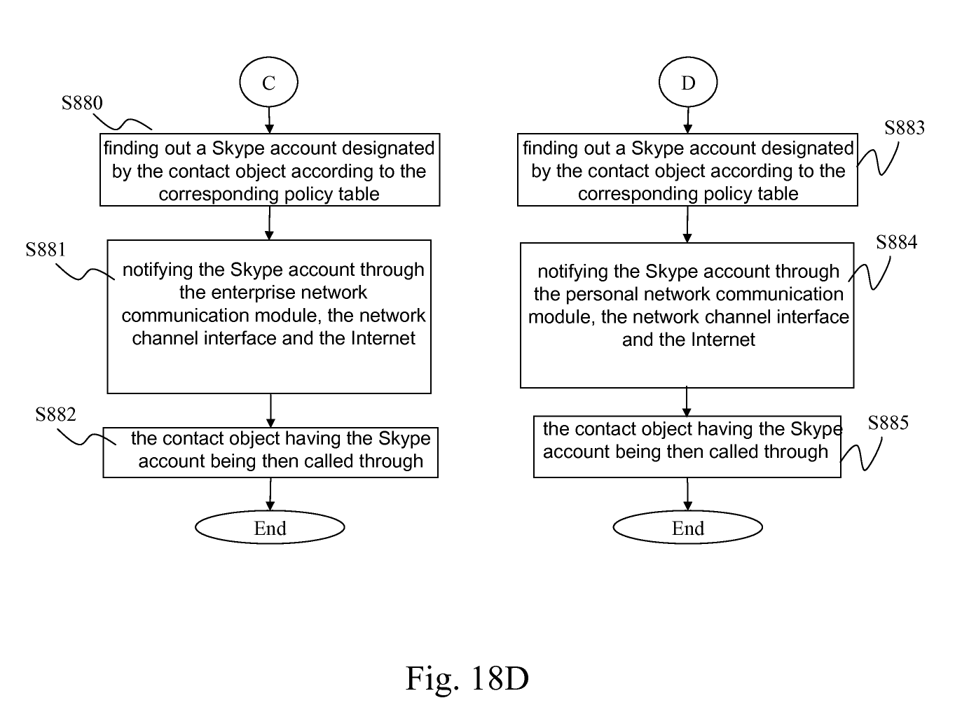

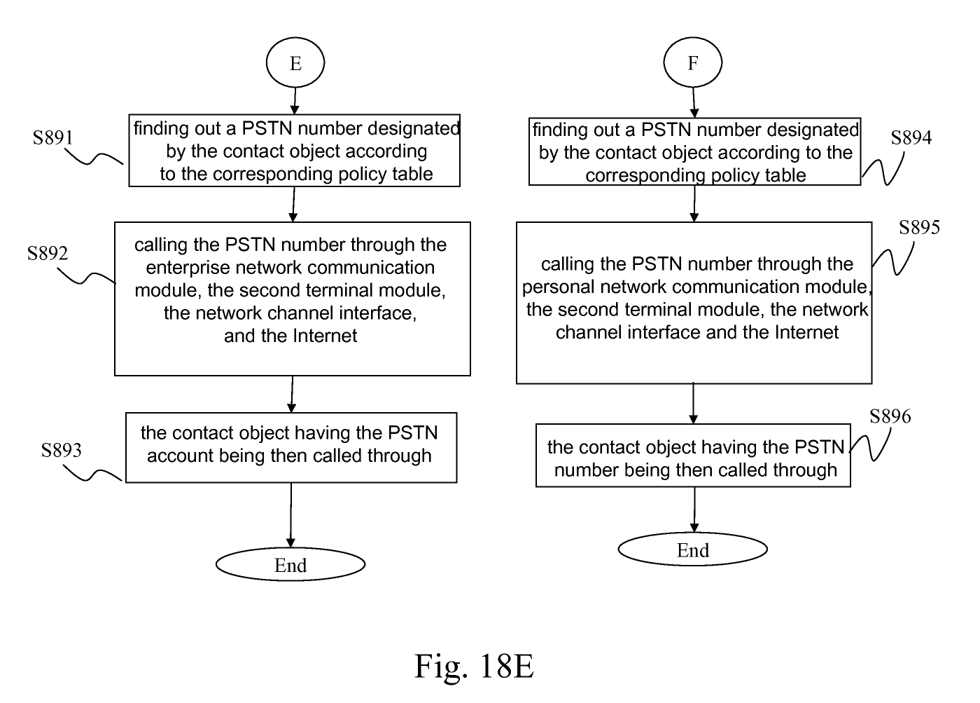

For more details, with references to FIG. 18A to FIG. 18E, which illustrate a flow chart of the fourth preferred embodiment of the network communication method for supporting the non-specific network protocols of the present invention. The method comprises the steps of:

a user end entering the Internet server 890 in order to send out a log-in request signal (S800);
entering the database 880 to access data through the Internet server 890 in order to determine whether the log-in request signal is right (S810); if no, going back to (S800), if yes,
acquiring a corresponding policy table of the user end from the database 880 and deciding how the way to log-in is (S820), wherein the way to log-in comprises a way to logging in the first terminal module 821 (S830) and a way to logging in the second terminal module 822 (S840);
wherein the corresponding policy table at least comprising the columns of: Skype account and password, extension number, PSTN number, SIP account, preset path, and calling policy, wherein any column can be with a plurality of data in order to have a capacity for extension, wherein the calling policy is defined as a way for a user end logging in, for instance, a log-in account of a high-level manager being used, the log-in account may be entered into the second terminal module 822, and general employees are thus delivered to the first terminal account, so that the purpose of a flexible management is approached.
After (S830) or (S840), entering the database 880 to access a contact list of the user end through the presence unit 852, and downloading the contact list to the user end (S845);
the user end selecting at least one contact object of the contact list and sending out a calling request signal through the Internet network and the network channel interface 810, and sending out a calling out rule (S850), wherein the calling out rule is selected from the group consisting of: a calling through a Skype account and a calling through an SIP account;
wherein the SIP account is selected from the group consisting of: an MSN account, a Yahoo messenger account, a Google Talk account, etc.,
wherein the calling through an SIP account is that of entering the database 880 to access a corresponding SIP account and logging in the SIP account through the control signal unit 851 (S855);
after (S850) or (S855), finding out a callee path and the calling policy of the contact object according to the calling request signal (S860); and
proceeding a specific calling mode for calling out according to the corresponding policy table (S870);
wherein the callee end path comprises three modes, which are an extension mode (steps A and B), an Skype account mode (steps C and D) and a PSTN mode (steps E and F).
After step A, the steps being of:
requesting the user end to input an extension number through the first terminal module 821 (S871);
notifying the exchanging mechanism 870 through the enterprise network communication module 830 and the audio channel exchanging module 860 (S872);
the exchanging mechanism 870 delivering the information of a calling to the extension number (S873); and
the extension number being then called through (S874).
After step B, the steps being of:
finding out an extension number designated by the contact object according to the corresponding policy table (S875);
notifying the exchanging mechanism 870 through the personal network communication module 840 and the audio channel exchanging module 860 (S876);
the exchanging mechanism 870 delivering the information of a calling to the extension number (S877); and
the extension number being then called through (S878).
After step C, the steps being of:
finding out a Skype account designated by the contact object according to the corresponding policy table (S888);
notifying the Skype account through the enterprise network communication module 830, the network channel interface 810 and the Internet (S881); and
the contact object having the Skype account being then called through (S882).
After step D, the steps being of:
finding out a Skype account designated by the contact object according to the corresponding policy table (S883);
notifying the Skype account through the personal network communication module 840, the network channel interface and the Internet (S884); and
the contact object having the Skype account being then called through (S885).
After step E, the steps being of:
finding out a PSTN number designated by the contact object according to the corresponding policy table (S891);
calling the PSTN number through the enterprise network communication module 830, the second terminal module 822, the network channel interface 810, and the Internet (S892); and
the contact object having the PSTN account being then called through (S893).
After step F, the steps being of:
finding out a PSTN number designated by the contact object according to the corresponding policy table (S894);
calling the PSTN number through the personal network communication module 840, the second terminal module 822, the network channel interface 810 and the Internet (S895); and the contact object having the PSTN number being then called through (S896).

Through the method, the switch between the first terminal module 821 and the second terminal module 822 can be made, and only the user end using a PSTN number, the switch is thus necessary. Since the condition in the environment of Skype is under the Skype out mode, which can be charged. For the best cost-saving payment policy with different levels and the policy of personal lines and function-restricted, the way of switching between the two terminal modules is adopted so as to create a light-weight system. For instance, the second terminal module has a function for multi-session, which occupies a huge amount of resources. Thus, the switch between the terminal modules is a must. The method is to discuss a concept of high-flexibility. The flow chart of the method is not to limit the spirits of the present invention, and any technology equivalent to the spirits of the present invention may be within it.

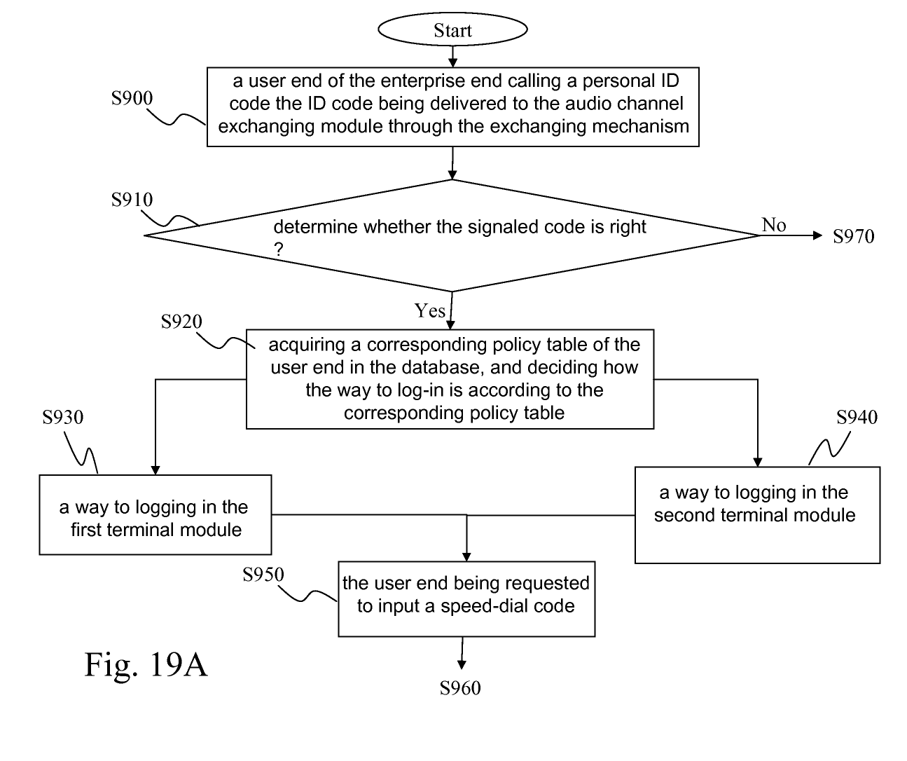

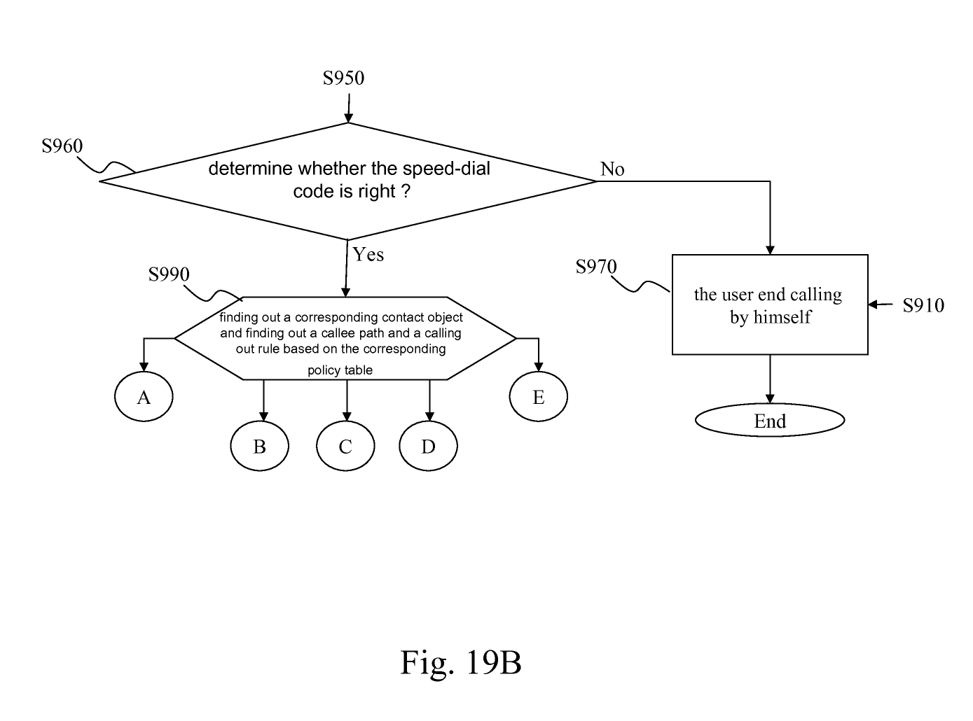

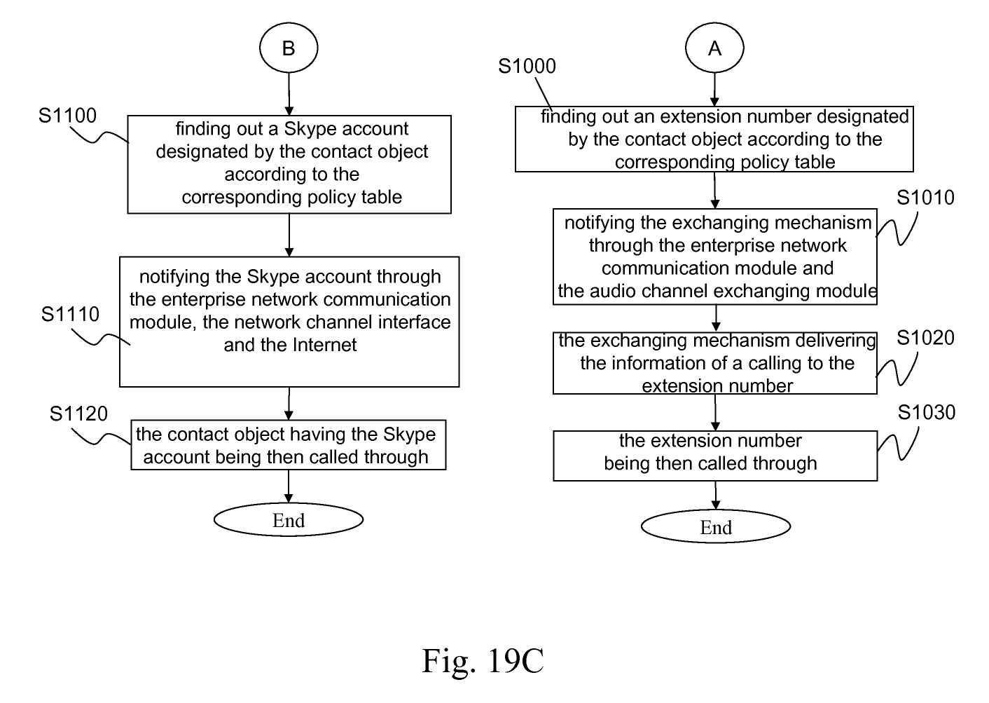

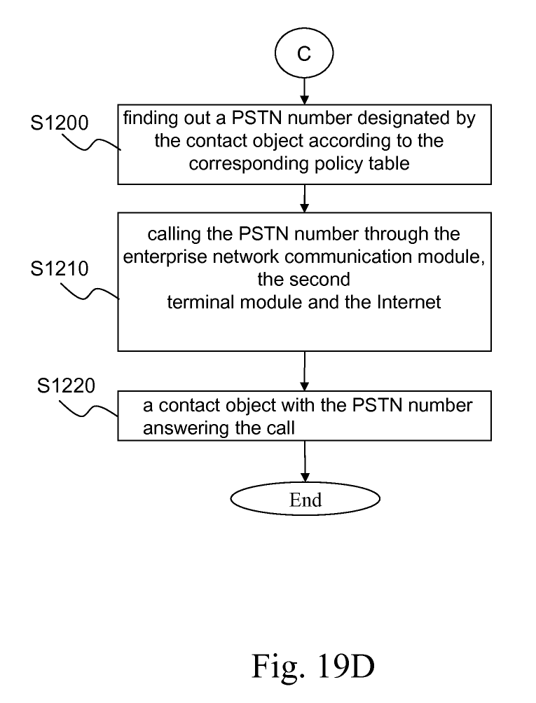

With references to FIG. 19A to FIG. 19D, which illustrate a call-out flow chart of the first preferred embodiment of the network communication method for supporting the non-specific network protocols of the present invention. The descriptions to FIG. 19A to FIG. 19D include the steps of:

a user end of the enterprise end calling a personal ID code, the ID code being delivered to the audio channel exchanging module 860 through the exchanging mechanism 870 (S900);
entering the database 880 through the control signal unit 870 to determine whether the signaled code is right (S910); if no, going to (S970), if yes,
acquiring a corresponding policy table of the user end in the database 880, and deciding how the way to log-in is according to the corresponding policy table (S920), wherein the way to log-in comprises a way to logging in the first terminal module 821 (S930) and a way to logging in the second terminal module 822 (S940);
wherein the corresponding policy table at least comprises the columns of: Skype account and password, extension number, PSTN number, SIP account, preset path, and calling policy; wherein any column can be with a plurality of data in order to have a capacity for extension, wherein the calling policy is defined as a way for a user end logging in, for instance, a log-in account of a high-level manager being used, the log-in account may be entered into the second terminal module 822, and general employees are thus delivered to the first terminal account, so that the purpose of a flexible management is approached
After (S930) or (S940), the user end being requested to input a speed-dial code (S950), wherein the speed-dial code and the ID code are respectively assemblies of numbers, symbols and characters;
entering the database 880 through the control signal unit 851 to determine whether the speed-dial code is right (S960); if no, the user end calling by himself (S970), wherein the call may not be through the corresponding policy table and may not be described any further hereinafter, if yes,
finding out a corresponding contact object and finding out a callee path and a calling out rule based on the corresponding policy table (S990) wherein the callee path at least comprises: an extension mode (Step A), a Skype account mode (Step B), and a PSTN mode (Step C);
after Step A, the steps being of:
finding out an extension number designated by the contact object according to the corresponding policy table (S1000);
notifying the exchanging mechanism 870 through the enterprise network communication module 830 and the audio channel exchanging module 860 (S1010);
the exchanging mechanism 860 delivering the information of a calling to the extension number (S1020); and
the extension number being then called through (S1030).
after Step B, the steps being of:
finding out a Skype account designated by the contact object according to the corresponding policy table (S1100);
notifying the Skype account through the enterprise network communication module 830, the network channel interface 810 and the Internet (S1110); and
a contact object with the Skype account answering the call (S1120).
after Step C, the steps being of:
finding out a PSTN number designated by the contact object according to the corresponding policy table (S1200);
calling the PSTN number through the enterprise network communication module, the second terminal module 822 and the Internet (S1210); and
a contact object with the PSTN number answering the call (S1220).

The difference between the two flow charts is that one calls out through an extension number and the other one calls out through a device with a browser. The two flow charts focus on the feature of the switch between the first terminal module and the second terminal module. Both have their own advantages, but may not be discussed any further hereinafter.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

We claim:

1. A network communication system for supporting non-specific network protocols, integrating presences in gateways and being as an exchanging mechanism among enterprise ends and external communications so as to represent the numbers of individual user ends and the representative numbers of the enterprise ends, comprising:
a network channel interface, delivering and acquiring the signals of network packets;
a network communication terminal module, processing network voice communications and at least comprising:
a personal network communication module, processing the ID information of the employees of the enterprise ends;
an enterprise network communication module, processing the ID information of the enterprise ends;
a core intermediate module, controlling and processing the signals of the network communication system, providing received data, processed data and delivered presence data, selecting audio channels, giving channel signal commands and parameters, processing the codes and decodes of the streams of audio signals, and proceeding the process of feed-in and feed-out; and
an audio channel exchanging module, building up, processing and maintaining the audio signals, and further detecting, filtering and generating telecommunication signals supported by hardware interfaces.

2. The network communication system for supporting the non-specific network protocols according to claim 1, wherein the network channel interface at least comprises: a transmission control protocol (TCP) and a user datagram protocol (UDP).

3. The network communication system for supporting the non-specific network protocols according to claim 1, wherein the audio channel exchanging module at least comprises: a session initiation protocol (SIP), an E1/T1 interface, a foreign eXchange station (FXS), and a foreign eXchange office (FXO).

4. A network communication method for supporting non-specific network protocols, integrating presences in gateways and being as an exchanging mechanism among enterprise ends and external communications by means of telephones so as to represent the numbers of individual user ends and the representative numbers of the enterprise ends, comprising the steps of:
a caller end of the enterprise end inputting a string signal;
delivering the string signal to a core intermediate module through an exchanging mechanism and an audio channel exchanging module;
the core intermediate module determining whether the string signal is without a personal ID code and a callee number, and deciding a delivering path;
proceeding a calling procedure according to an enterprise network communication module;
calling a callee end of a public switched telephone network (PSTN) through an audio channel exchanging module; and
the callee end answering the call.

5. The network communication method for supporting the non-specific network protocols according to claim 4, wherein the string signal is an assembly of a plurality of numbers, symbols and characters.

6. The network communication method for supporting the non-specific network protocols according to claim 4, wherein the step of proceeding the calling procedure according to the enterprise network communication module further comprises the step of calling a callee end of a voice over internet protocol (VOIP) through a network channel interface and the Internet.

7. The network communication method for supporting the non-specific network protocols according to claim 4, wherein the step of the core intermediate module determining whether the string signal is without a personal ID code, and deciding a delivering path, if no, proceeding a calling procedure according to a personal network communication module.

8. The network communication method for supporting the non-specific network protocols according to claim 7, wherein the step of proceeding the calling procedure according to the personal network communication module comprises the steps of: calling the callee end of the public switched telephone network (PSTN) through the audio channel exchanging module and calling a callee end of a voice over Internet protocol (VOIP) through a network channel interface and the Internet.

9. A network communication system for supporting non-specific network protocols, integrating presences in gateways and being as an exchanging mechanism among enterprise ends and external communications so as to log in for confirming presences via Internet browsers for representing the numbers of individual user ends and the representative numbers of the enterprise ends, comprising:
a network channel interface, delivering and acquiring the signals of network packets;
a network communication terminal module, processing Network voice communications and at least comprising:
a personal network communication module, processing the ID information of the employees of the enterprise ends;
an enterprise network communication module, processing the ID information of the enterprise ends;
a core intermediate module, controlling and processing the signals of the network communication system, providing received data, processed data and delivered presence data, selecting audio channels, giving channel signal commands and parameters, and processing the codes and decodes of the streams of audio signals, and proceeding the process of feed-in and feed-out;
an Internet server, delivering and acquiring a message and a control signal, acquiring all log-in demands, and communicating with the personal network communication module and the enterprise network communication module;
a database, storing the confirmations of the log-ins of user ends, authorization information, policy tables, and the authorization and confirmation information in the network communication terminal module; and
an audio channel exchanging module, building up, processing and maintaining the audio signals, and further detecting, filtering and generating telecommunication signals supported by hardware interfaces.

10. The network communication system for supporting the non-specific network protocols according to claim 9, wherein the network channel interface at least comprises: a transmission control protocol (TCP) and a user datagram protocol (UDP).

11. The network communication system for supporting the non-specific network protocols according to claim 9, wherein the audio channel exchanging module at least comprises: a session initiation protocol (SIP), an E1/T1 interface, a foreign eXchange station (FXS), and a foreign eXchange office (FXO).

12. A network communication method for supporting non-specific network protocols, integrating presences in gateways and being as an exchanging mechanism among enterprise ends and external communications so as to log in for confirming presences via Internet browsers for representing the numbers of individual user ends and the representative numbers of the enterprise ends, the method being mainly applied to a calling procedure from one of the enterprise ends and comprising the steps of:
a user end in the enterprise end entering an Internet server in order to send out a log-in request signal;
entering a database to access data through the Internet server in order to determine whether the log-in request signal is right;
entering the database to access a contact list of the user end through a core intermediate module, and downloading the contact list to the user end;
the user end selecting at least one contact object of the contact list and sending out a calling request signal;
through the core intermediate module, entering the database to access a corresponding policy table for finding out a callee path and a calling policy of the contact object according to the calling request signal;
proceeding a specific calling mode for calling out according to the corresponding policy table; and
the contact object answering the call.

13. The network communication system for supporting the non-specific network protocols according to claim 12, wherein the step of proceeding the specific calling mode for calling out further comprises the steps of: proceeding a calling procedure based on an enterprise network communication module and proceeding another calling procedure based on a personal network communication module.

14. The network communication system for supporting the non-specific network protocols according to claim 13, wherein the step of proceeding the calling procedure based on an enterprise network communication module comprises the steps of: calling the callee end of a public switched telephone network (PSTN) through an audio channel exchanging module and calling a callee end of a voice over Internet protocol (VOIP) through a network channel interface and the Internet.

15. The network communication system for supporting the non-specific network protocols according to claim 13, wherein the step of proceeding the calling procedure based on an enterprise network communication module comprises the steps of: calling the callee end of a public switched telephone network (PSTN) through an audio channel exchanging module and calling a callee end of a voice over Internet protocol (VOIP) through a network channel interface and the Internet.

16. A network communication system for supporting non-specific network protocols, being applied to a multiple communication way in gateways in order to make enterprise ends easily manage the communications thereof and approach the effect of unifying communications, and the numbers of individual user ends and the representative numbers of the enterprise ends being shown, comprising:
a network channel interface, delivering and acquiring the signals of network packets;
a network communication terminal module, processing Network voice communications and at least comprising:
a personal network communication module, processing the ID information of the employees of the enterprise ends;
an enterprise network communication module, processing the ID information of the enterprise ends;
a core intermediate module, controlling and processing the signals of the network communication system, processing the codes and decodes of the streams of audio signals, and proceeding the process of feed-in and feed-out, comprising:
a control signal unit, selecting audio channels, giving channel signal commands and parameters;
a presence unit, acquiring, processing and delivering presence data acquired by the network communication terminal module, wherein the presence data are translated and delivered out;
an instant message relay unit, acquiring instant messages from the network communication terminal module, wherein the instant messages are translated and delivered out;
a representative log-in unit, switching log-in information in the system stored by the user ends to different accounts to replace the operations of the user ends;
an Internet server, delivering and acquiring a message and a control signal, acquiring all log-in demands, and communicating with the personal network communication module and the enterprise network communication module, delivering instant messages to the instant message relay unit, the instant messages being translated and delivered out by the instant message relay unit after the instant message relay unit acquires the instant messages;
a database, storing the confirmations of the log-ins of user ends, authorization information, policy tables, and the authorization and confirmation information in the personal network communication module and the enterprise network communication module; and
an audio channel exchanging module, building up, processing and maintaining the audio signals, and further detecting, filtering and generating telecommunication signals supported by hardware interfaces, the control signal unit ordering the audio channel exchanging module.

17. The network communication system for supporting the non-specific network protocols according to claim 16, wherein the network channel interface at least comprises: a transmission control protocol (TCP) and a user datagram protocol (UDP).

18. The network communication system for supporting the non-specific network protocols according to claim 16, wherein the audio channel exchanging module at least comprises: a session initiation protocol (SIP), an E1/T1 interface, a foreign eXchange station (FXS), and a foreign eXchange office (FXO).

19. A network communication method for supporting non-specific network protocols, being applied to a multiple communication way in gateways in order to make enterprise ends easily manage the communications thereof and approach the effect of unifying communications, and the numbers of individual user ends and the representative numbers of the enterprise ends being shown, comprising the steps of:
a user end entering an Internet server in order to send out a log-in request signal;
entering a database to access data through the Internet server in order to determine whether the log-in request signal is right;
entering the database to access a contact list of the user end through a presence unit, and downloading the contact list to the user end;
the user end selecting at least one contact object of the contact list and sending out a calling request signal through an Internet network and a network channel interface, and sending out a calling out rule to a network communication terminal module;
through a control signal unit, entering the database to access a corresponding policy table for finding out a callee path and a calling policy of the contact object according to the calling request signal;
proceeding a specific calling mode for calling out according to the corresponding policy table; and
the contact object answering the call, so that the user end communicates with the contact object.

20. The network communication method for supporting the non-specific network protocols according to claim 19, wherein the calling out rule is selected from the group consisting of: a calling through a Skype account, a calling through an SIP account and a calling through an original phone number of an enterprise end.

21. The network communication method for supporting the non-specific network protocols according to claim 20, wherein the calling through a Skype account is that of entering a database to access a corresponding Skype account and logging in the Skype account through a representative log-in unit and the control signal unit.

22. The network communication method for supporting the non-specific network protocols according to claim 20, wherein the calling through an SIP account is that of entering a database to access a corresponding SIP account and logging in the SIP account through a representative log-in unit and the control signal unit.

23. The network communication method for supporting the non-specific network protocols according to claim 20, wherein the SIP account is selected from the group consisting of: an MSN account, a Yahoo messenger account and a Google Talk account.

24. The network communication method for supporting the non-specific network protocols according to claim 19, wherein the corresponding policy table at least comprises the columns of: Skype account and password, extension number, PSTN number, SIP account, preset path, and calling policy.

25. The network communication method for supporting the non-specific network protocols according to claim 19, wherein the callee path at least comprises: an extension mode, a Skype account mode, an SIP mode, and a PSTN mode.

26. The network communication method for supporting the non-specific network protocols according to claim 25, wherein the extension mode has two ways for calling, the ways are of a calling through an enterprise network communication module and a calling through a personal network communication module.

27. The network communication method for supporting the non-specific network protocols according to claim 26, wherein the calling through an enterprise network communication module comprises the steps of:
requesting the user end to input an extension number through the network communication terminal module;
notifying an exchanging mechanism through the enterprise network communication module and an audio channel exchanging module;
the exchanging mechanism delivering the information of a calling to the extension number; and
the extension number being then called through.

28. The network communication method for supporting the non-specific network protocols according to claim 26, wherein the calling through a personal network communication module comprises the steps of:
finding out an extension number according to the corresponding policy table;
notifying an exchanging mechanism through the personal network communication module and an audio channel exchanging module;
the exchanging mechanism delivering the information of a calling to the extension number; and
the extension number being then called through.

29. The network communication method for supporting the non-specific network protocols according to claim 25, wherein the Skype account mode has two ways for calling, the ways are of a calling through an enterprise network communication module and a calling through a personal network communication module.

30. The network communication method for supporting the non-specific network protocols according to claim 29, wherein the calling through an enterprise network communication module comprises the steps of:
finding out a Skype account designated by the contact object according to the corresponding policy table;
notifying the Skype account through the enterprise network communication module, the network channel interface and the Internet; and
the contact object having the Skype account being then called through.

31. The network communication method for supporting the non-specific network protocols according to claim 29, wherein the calling through a personal network communication module comprises the steps of:
finding out a Skype account designated by the contact object according to the corresponding policy table;
notifying the Skype account through the personal network communication module, the network channel interface and the Internet; and
the contact object having the Skype account being then called through.

32. The network communication method for supporting the non-specific network protocols according to claim 25, wherein the PSTN account mode has two ways for calling, the ways are of a calling through an enterprise network communication module and a calling through a personal network communication module.

33. The network communication method for supporting the non-specific network protocols according to claim 32, wherein the calling through an enterprise network communication module comprises the steps of:
finding out a PSTN number designated by the contact object according to the corresponding policy table;
calling the PSTN number through the enterprise network communication module, the network channel interface and the Internet; and
the contact object having the PSTN account being then called through.

34. The network communication method for supporting the non-specific network protocols according to claim 32, wherein the calling through a personal network communication module comprises the steps of:
finding out a PSTN number designated by the contact object according to the corresponding policy table;
calling the PSTN number through the personal network communication module, the network channel interface and the Internet; and
the contact object having the PSTN number being then called through.

35. The network communication method for supporting the non-specific network protocols according to claim 25, wherein the SIP account mode has two ways for calling, the ways are of a calling through a network channel interface and a calling through an enterprise network exchanging mechanism.

36. The network communication method for supporting the non-specific network protocols according to claim 35, wherein the calling through a network channel interface has two ways for calling, the ways are of a calling through an enterprise network communication module and a calling through a personal network communication module.

37. The network communication method for supporting the non-specific network protocols according to claim 36, wherein the calling through an enterprise network communication module comprises the steps of:
finding out an SIP account designated by the contact object according to the corresponding policy table;
notifying the SIP account through the enterprise network communication module, the network channel interface and the Internet; and
the contact object having the SIP account being then called through.

38. The network communication method for supporting the non-specific network protocols according to claim 36, wherein the calling through a personal network communication module comprises the steps of:
finding out an SIP account designated by the contact object according to the corresponding policy table;
notifying the SIP account through the personal network communication module, the network channel interface and the Internet; and
the contact object having the SIP number being then called through.

39. The network communication method for supporting the non-specific network protocols according to claim 35, wherein the calling through an enterprise network interface has two ways for calling, the ways are of a calling through an enterprise network communication module and a calling through a personal network communication module.

40. The network communication method for supporting the non-specific network protocols according to claim 39, wherein the calling through an enterprise network communication module comprises the steps of:
finding out an SIP account designated by the contact object according to the corresponding policy table;
notifying the SIP account through the enterprise network communication module, the audio channel exchanging module and the enterprise network exchanging mechanism; and
the contact object having the SIP account being then called through.

41. The network communication method for supporting the non-specific network protocols according to claim 39, wherein the calling through a personal network communication module comprises the steps of:
finding out an SIP account designated by the contact object according to the corresponding policy table;
notifying the SIP account through the personal network communication module, the audio channel exchanging module and the enterprise network exchanging mechanism; and
the contact object having the SIP number being then called through.

42. A network communication system for supporting non-specific network protocols, being applied to a Skype way in gateways in order to make enterprise ends easily manage the communications of the Skype, and the numbers of individual user ends and the representative numbers of the enterprise ends being shown, comprising:
a network channel interface, delivering and acquiring the signals of network packets;
a network communication terminal module, processing Network voice communications and at least comprising:
a personal network communication module, processing the ID information of the employees of the enterprise ends;
an enterprise network communication module, processing the ID information of the enterprise ends;
a core intermediate module, controlling and processing the signals of the network communication system, processing the codes and decodes of the streams of audio signals, and proceeding the process of feed-in and feed-out, comprising:
a control signal unit, selecting audio channels, giving channel signal commands and parameters;
a presence unit, acquiring, processing and delivering presence data acquired by the network communication terminal module, wherein the presence data are translated and delivered out;
an instant message relay unit, acquiring instant messages from the network communication terminal module, wherein the instant messages are translated and delivered out;
an Internet server, delivering and acquiring a message and a control signal, acquiring all log-in demands, and communicating with the network communication terminal module, delivering instant messages to the instant message relay unit, the instant messages being translated and delivered out by the instant message relay unit after the instant message relay unit acquires the instant messages;
a database, storing the confirmations of the log-ins of user ends, authorization information, policy tables, and the authorization and confirmation information in the network communication terminal module; and
an audio channel exchanging module, building up, processing and maintaining the audio signals, and further detecting, filtering and generating telecommunication signals supported by hardware interfaces, the control signal unit ordering the audio channel exchanging module.

43. The network communication system for supporting the non-specific network protocols according to claim 42, wherein the network channel interface at least comprises: a transmission control protocol (TCP) and a user datagram protocol (UDP).

44. The network communication system for supporting the non-specific network protocols according to claim 42, wherein the audio channel exchanging module at least comprises: a session initiation protocol (SIP), an E1/T1 interface, a foreign eXchange station (FXS), and a foreign eXchange office (FXO).

45. A network communication method for supporting non-specific network protocols, being applied to a Skype way in gateways in order to make enterprise ends easily manage the communications of the Skype, and the numbers of individual user ends and the representative numbers of the enterprise ends being shown, comprising the steps of:
a starting end logging in a network communication server;
downloading a contact list through a network communication system of supporting the system;
the starting end selecting a contact object of the contact list and making a plurality of calls based on different calling modes;
the network communication system for supporting the non-specific network protocols making a call to a caller end;
the caller end answering the call;
the network communication system for supporting the non-specific network protocols making a call to a callee end; and
the callee end answering the call.

46. The network communication method for supporting the non-specific network protocols according to claim 45, wherein the calling modes at least comprise: a mode of simultaneously calling all callee end paths, a mode of calling all callee end paths in order, and a mode of calling preset callee end paths.

47. The network communication method for supporting the non-specific network protocols according to claim 46, wherein the mode of simultaneously calling all callee end paths is that of other callee end paths being interrupted while one callee end path is answered.

48. A network communication method for supporting non-specific network protocols, being applied to a Skype way in gateways in order to make enterprise ends easily manage the communications of the Skype, and the numbers of individual user ends and the representative numbers of the enterprise ends being shown, comprising the steps of:
a starting end entering an Internet server in order to send out a log-in request signal;
entering a database to access data through the Internet server in order to determine whether the log-in request signal is right;
entering the database to access a contact list of the starting end through a presence unit, and downloading the contact list to the starting end;
the starting end selecting at least one contact object ( [symbol] ) of the contact list and sending out a calling request signal;
the Internet server acquiring the calling request signal and accessing a calling mode of the database set by the starting end to process;
a caller end sending out an answering signal;
a control signal unit access a communication mode of the database set by the contact object;
determining whether the contact object answers the call; and
the caller end communicating with the contact object.

49. The network communication method for supporting the non-specific network protocols according to claim 48, wherein the calling mode is defined that of calling a caller end designated by the starting end, at least comprise: a mode of simultaneously calling all callee end paths, a mode of calling all callee end paths in order, and a mode of calling preset callee end paths.

50. The network communication method for supporting the non-specific network protocols according to claim 46, wherein the mode of simultaneously calling all callee end paths is that of other callee end paths being interrupted while one callee end path is answered.

51. The network communication method for supporting the non-specific network protocols according to claim 49, wherein the callee end path comprises three modes, which are an extension mode, an outside (Skype out) mode and a Skype (Skype in) mode.

52. The network communication method for supporting the non-specific network protocols according to claim 51, wherein the extension mode for calling comprises the steps of:
delivering to an exchanging mechanism through an enterprise network communication module and an audio channel exchanging module according to a corresponding extension number;
the exchanging mechanism calling a caller end corresponding to the extension number;
determining whether an answering signal from the caller end is sent back to the exchanging mechanism; and
the exchanging mechanism sending the answering signal back to the control signal unit.

53. The network communication method for supporting the non-specific network protocols according to claim 51, wherein the outside (Skype out) mode for calling comprises the steps of:
calling a caller end through an enterprise network communication module and a network channel interface according to a corresponding PSTN number;
determining whether an answering signal from the caller end is sent back to the enterprise network communication module; and
the enterprise network communication module sending the answering signal back to the control signal unit.

54. The network communication method for supporting the non-specific network protocols according to claim 51, wherein the Skype (Skype in) mode for calling comprises the steps of:
calling a caller end through an enterprise network communication module and a network channel interface according to a corresponding Skype account;
determining whether an answering signal from the caller end is sent back to the enterprise network communication module; and
the enterprise network communication module sending the answering signal back to the control signal unit.

55. The network communication method for supporting the non-specific network protocols according to claim 48, wherein the calling modes at least comprise: a mode of simultaneously calling all callee end paths, a mode of calling all callee end paths in order, and a mode of calling preset callee end paths.

56. The network communication method for supporting the non-specific network protocols according to claim 55, wherein the mode of simultaneously calling all callee end paths is that of other callee end paths being interrupted while one callee end path is answered.

57. The network communication method for supporting the non-specific network protocols according to claim 55, wherein the callee end path comprises three modes, which are an extension mode, an outside (Skype out) mode and a Skype (Skype in) mode.

58. The network communication method for supporting the non-specific network protocols according to claim 57, wherein the extension mode for calling comprises the steps of:
delivering to an exchanging mechanism through an enterprise network communication module and an audio channel exchanging module according to a corresponding extension number; and
the exchanging mechanism calling a callee end corresponding to the extension number.

59. The network communication method for supporting the non-specific network protocols according to claim 57, wherein the outside (Skype out) mode for calling comprises two procedures, which are of: a calling through an enterprise network communication module and a calling through a personal network communication module.

60. The network communication method for supporting the non-specific network protocols according to claim 59, wherein the procedure of the calling through the enterprise network communication module is defined that of calling a callee end through the enterprise network communication module and a network channel interface according to a corresponding PSTN number.

61. The network communication method for supporting the non-specific network protocols according to claim 59, wherein the procedure of the calling through the personal network communication module is defined that of calling a callee end through the personal network communication module and a network channel interface according to a corresponding PSTN number.

62. The network communication method for supporting the non-specific network protocols according to claim 57, wherein the Skype (Skype in) mode for calling comprises two procedures, which are of: a calling through an enterprise network communication module and a calling through a personal network communication module.

63. The network communication method for supporting the non-specific network protocols according to claim 62, wherein the procedure of the calling through the enterprise network communication module is defined that of calling a caller end through the enterprise network communication module and a network channel interface according to a corresponding Skype account.

64. The network communication method for supporting the non-specific network protocols according to claim 62, wherein the procedure of the calling through the personal network communication module is defined that of calling a callee end through the personal network communication module and a network channel interface according to a corresponding Skype account.

65. A network communication system for supporting non-specific network protocols, being applied to a Skype way in gateways in order to make enterprise ends easily manage the communications of the Skype and approach features of light-weight and high-flexibility, and the numbers of individual user ends and the representative numbers of the enterprise ends being shown, comprising:
a network channel interface, delivering and acquiring the signals of network packets;
a network communication terminal module, processing Network voice communications and at least comprising:
a personal network communication module, processing the ID information of the employees of the enterprise ends;
an enterprise network communication module, processing the ID information of the enterprise ends, at least comprising two terminal modules for providing multiple service levels and dynamic configurations, wherein the two terminal modules are a first terminal module (Micro) and a second terminal module (Normal);
a core intermediate module, controlling and processing the signals of the network communication system, processing the codes and decodes of the streams of audio signals, and proceeding the process of feed-in and feed-out, comprising:
a control signal unit, selecting audio channels, giving channel signal commands and parameters;
a presence unit, acquiring, processing and delivering presence data acquired by the network communication terminal module, wherein the presence data are translated and delivered out;
an instant message relay unit, acquiring instant messages from the network communication terminal module, wherein the instant messages are translated and delivered out;
an Internet server, delivering and acquiring a message and a control signal, acquiring all log-in demands, and communicating with the network communication terminal module, delivering instant messages to the instant message relay unit, the instant messages being translated and delivered out by the instant message relay unit after the instant message relay unit acquires the instant messages;
a database, storing the confirmations of the log-ins of user ends, authorization information, policy tables, and the authorization and confirmation information in the network communication terminal module; and
an audio channel exchanging module, building up, processing and maintaining the audio signals, and further detecting, filtering and generating telecommunication signals supported by hardware interfaces, the control signal unit ordering the audio channel exchanging module.

66. The network communication system for supporting the non-specific network protocols according to claim 65, wherein the network channel interface at least comprises: a transmission control protocol (TCP) and a user datagram protocol (UDP).

67. The network communication system for supporting the non-specific network protocols according to claim 65, wherein the audio channel exchanging module at least comprises: a session initiation protocol (SIP), an E1/T1 interface, a foreign eXchange station (FXS), and a foreign eXchange office (FXO).

68. A network communication method for supporting non-specific network protocols, being applied to a Skype way in gateways in order to make enterprise ends easily manage the communications of the Skype and approach features of light-weight and high-flexibility, and the numbers of individual user ends and the representative numbers of the enterprise ends being shown, comprising the steps of:
a user end entering an Internet server in order to send out a log-in request signal;
entering a database to access data through the Internet server in order to determine whether the log-in request signal is right;
acquiring a corresponding policy table of the user end from the database and deciding how the way to log-in is;
entering the database to access a contact list of the user end through a presence unit, and downloading the contact list to the user end;
the user end selecting at least one contact object of the contact list and sending out a calling request signal through an Internet network and a network channel interface, and sending out a calling out rule;
finding out a callee path and the calling policy of the contact object according to the calling request signal;
proceeding a specific calling mode for calling out according to the corresponding policy table; and
the contact object answering the call, so that the user end communicates with the contact object.

69. The network communication method for supporting non-specific network protocols according to claim 68, wherein the way to log-in comprises a way to logging in a first terminal module and a way to logging in a second terminal module.

70. The network communication method for supporting non-specific network protocols according to claim 68, wherein the calling out rule is selected from the group consisting of: a calling through a Skype account and a calling through an SIP account.

71. The network communication method for supporting the non-specific network protocols according to claim 70, wherein the SIP account is selected from the group consisting of: an MSN account, a Yahoo messenger account and a Google Talk account.

72. The network communication method for supporting the non-specific network protocols according to claim 68, wherein the corresponding policy table at least comprises the columns of: Skype account and password, extension number, PSTN number, SIP account, preset path, and calling policy.

73. The network communication method for supporting the non-specific network protocols according to claim 69, wherein the callee path at least comprises: an extension mode, a Skype account mode, an SIP mode, and a PSTN mode.

74. The network communication method for supporting the non-specific network protocols according to claim 73, wherein the extension mode has two ways for calling, the ways are of a calling through an enterprise network communication module and a calling through a personal network communication module.

75. The network communication method for supporting the non-specific network protocols according to claim 74, wherein the calling through an enterprise network communication module comprises the steps of:
requesting the user end to input an extension number through the first terminal module;
notifying the exchanging mechanism through the enterprise network communication module and the audio channel exchanging module;
the exchanging mechanism delivering the information of a calling to the extension number; and
the extension number being then called through.

76. The network communication method for supporting the non-specific network protocols according to claim 74, wherein the calling through a personal network communication module comprises the steps of:
finding out an extension number designated by the contact object according to the corresponding policy table;
notifying an exchanging mechanism through the personal network communication module and an audio channel exchanging module;
the exchanging mechanism delivering the information of a calling to the extension number; and
the extension number being then called through.

77. The network communication method for supporting the non-specific network protocols according to claim 73, wherein the Skype account mode has two ways for calling, the ways are of a calling through an enterprise network communication module and a calling through a personal network communication module.

78. The network communication method for supporting the non-specific network protocols according to claim 77, wherein the calling through an enterprise network communication module comprises the steps of:
finding out a Skype account designated by the contact object according to the corresponding policy table;
notifying the Skype account through the enterprise network communication module, the network channel interface and the Internet; and
the contact object having the Skype account being then called through.

79. The network communication method for supporting the non-specific network protocols according to claim 77, wherein the calling through a personal network communication module comprises the steps of:
finding out a Skype account designated by the contact object according to the corresponding policy table;
notifying the Skype account through the personal network communication module, the network channel interface and the Internet; and
the contact object having the Skype account being then called through.

80. The network communication method for supporting the non-specific network protocols according to claim 73, wherein the PSTN account mode has two ways for calling, the ways are of a calling through an enterprise network communication module and a calling through a personal network communication module.

81. The network communication method for supporting the non-specific network protocols according to claim 80, wherein the calling through an enterprise network communication module comprises the steps of:
finding out a PSTN number designated by the contact object according to the corresponding policy table;
calling the PSTN number through the enterprise network communication module, the second terminal module, the network channel interface, and the Internet; and
the contact object having the PSTN account being then called through.

82. The network communication method for supporting the non-specific network protocols according to claim 80, wherein the calling through a personal network communication module comprises the steps of:
finding out a PSTN number designated by the contact object according to the corresponding policy table;
calling the PSTN number through the personal network communication module, the second terminal module, the network channel interface and the Internet; and
the contact object having the PSTN number being then called through.

83. A network communication method for supporting non-specific network protocols, being applied to a Skype way in gateways in order to make enterprise ends easily manage the communications of the Skype and approach features of light-weight and high-flexibility, and the numbers of individual user ends and the representative numbers of the enterprise ends being shown, the method being mainly applied to a procedure of using extension numbers to call out in an enterprise end and comprising the steps of:
a user end of the enterprise end calling a personal ID code, the ID code being delivered to an audio channel exchanging module through an exchanging mechanism;
entering a database through a control signal unit to determine whether the signaled code is right;
acquiring a corresponding policy table of the user end in the database, and deciding how the way to log-in is according to the corresponding policy table;
the user end being requested to input a speed-dial code ( [symbol] );
entering the database through the control signal unit to determine whether the speed-dial code is right;
finding out a corresponding contact object and finding out a callee path and a calling out rule based on the corresponding policy table;
proceeding a specific calling mode for calling out according to the corresponding policy table; and
the contact object answering the call, so that the user end communicates with the contact object.

84. The network communication method for supporting non-specific network protocols according to claim 83, wherein the way to log-in comprises a way to logging in a first terminal module and a way to logging in a second terminal module.

85. The network communication method for supporting non-specific network protocols according to claim 83, wherein the speed-dial code and the ID code are respectively assemblies of numbers, symbols and characters.

86. The network communication method for supporting the non-specific network protocols according to claim 83, wherein the corresponding policy table at least comprises the columns of: Skype account and password, extension number, PSTN number, SIP account, preset path, and calling policy.

87. The network communication method for supporting the non-specific network protocols according to claim 83, wherein the callee path at least comprises: an extension mode, a Skype account mode, an SIP mode, and a PSTN mode.

88. The network communication method for supporting the non-specific network protocols according to claim 87, wherein the extension mode comprising the steps of:
finding out an extension number designated by the contact object according to the corresponding policy table;
notifying an exchanging mechanism through the enterprise network communication module and an audio channel exchanging module;
the exchanging mechanism delivering the information of a calling to the extension number; and
the extension number being then called through.

89. The network communication method for supporting the non-specific network protocols according to claim 87, wherein the Skype account mode comprising the steps of:
finding out a Skype account designated by the contact object according to the corresponding policy table;
notifying the Skype account through an enterprise network communication module, a network channel interface and an Internet; and
a contact object with the Skype account answering the call.

90. The network communication method for supporting the non-specific network protocols according to claim 87, wherein the PSTN mode comprising the steps of:
finding out a PSTN number designated by the contact object according to the corresponding policy table;
calling the PSTN number through an enterprise network communication module, the second terminal module and an Internet; and
a contact object with the PSTN number answering the call.
